(19) United States
(12) Patent Application Publication
(10) Pub. No.: US 2010/0027117 A1
(43) Pub. Date: Feb. 4, 2010

(54) Hardcoat film, production method of hardcoat film, antireflection film, polarizing plate and display device

(75) Inventors: Takato Suzuki, Kanagawa (JP); Tetsuya Asakura, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/458,878

(22) Filed: Jul. 27, 2009

(30) Foreign Application Priority Data
Jul. 29, 2008 (JP) 2008-195164

(51) Int. Cl. G02B 1/08; B32B 23/00; B32B 5/16; G02B 5/30

(52) U.S. Cl. 359/500; 428/336; 428/323; 428/328; 428/329

(57) ABSTRACT

A hardcoat film is provided, the hardcoat film including: a cellulose acylate film containing at least a base layer and a surface layer; and a hardcoat layer disposed at a surface layer side of the cellulose acylate film, wherein the surface layer contains inorganic oxide fine particles and a cellulose acylate, the surface layer has a refractive index of from 1.49 to 1.56 and an average film thickness of from 50 to 130 nm, and the hardcoat film satisfies formula (I):

0.98<(nH×nC)^{1/2}/nS<1.02 Formula (I)

where nH represents a refractive index of the hardcoat layer; nS represents a refractive index of the surface layer; and nC represents a refractive index of the cellulose acylate film other than the surface layer.

### BACKGROUND OF THE INVENTION

1. Field of the Invention

The present invention relates to a hardcoat film, a production method of a hardcoat film, an antireflection film, a polarizing plate and a display device.

2. Description of the Related Art

With recent progress of a large-screen liquid crystal display device (LCD), a liquid crystal display device having disposed therein an optical film such as antireflection film is increasing. For example, in various image display devices such as liquid crystal display (LCD), plasma display panel (PDP), electroluminescent display (ELD) and cathode ray tube display device (CRT), an antireflection film is disposed on the display surface so as to prevent reduction in the contrast due to reflection of outside light or disturbing reflection of an image.

The antireflection film that is a kind of optical film is produced by forming a hardcoat layer on a transparent support or by stacking a high refractive index layer, a low refractive index layer and the like on the hardcoat layer. Particularly, in an antireflection film for liquid crystal display devices, the above-described layers are formed on a cellulose acylate film such as triacetyl cellulose that is a transparent support, and the obtained film is used as an antireflection film.

However, when a hardcoat layer is stacked on a cellulose acylate film, the reflected light from the interface between the cellulose acylate film and the hardcoat layer and the reflected light on the hardcoat layer surface interfere with each other and the reflected light is tinted to bring about interference unevenness of causing the tint to change in correspondence to the film thickness unevenness of the hardcoat layer. The interference unevenness impairs the outer appearance of the image display device and it is necessary to be prevented from occurring.

In order to solve this problem, a technique of providing an intermediate layer on a cellulose acylate film to have a film thickness of about 100 nm and be adjusted to a medium refractive index between the cellulose acylate film and the hardcoat layer and forming thereon a hardcoat layer is known (JP-A-2005-107005, the term “JP-A” as used herein means an “unexamined published Japanese patent application”).

### SUMMARY OF THE INVENTION

The technique of JP-A-2005-107005 can improve the interference unevenness, but the adherence between the intermediate layer and the cellulose acylate film is sometimes reduced. Also, since an intermediate layer is provided, one coating step is increased from the number of coatings in conventional techniques and the productivity decreases.

An object of the present invention is to solve those problems and provide a hardcoat film succeeded in having an interference unevenness-preventing function without reducing the adherence by imparting an interference unevenness-preventing function to a transparent support itself composed of cellulose acylate. Another object of the present invention is to provide a production method capable of producing a hardcoat film without increasing the number of coatings.

As a result of continuing intensive studies, the above-described objects can be attained by the following means.

(1) A hardcoat film, including:

a cellulose acylate film containing at least a base layer and a surface layer; and

a hardcoat layer disposed at a surface layer side of the cellulose acylate film,

wherein the surface layer contains inorganic oxide fine particles and a cellulose acylate,

the surface layer has a refractive index of from 1.49 to 1.56 and an average film thickness of from 50 to 130 nm, and

the hardcoat film satisfies formula (I):

0.98<(nH×nC)^{1/2}/nS<1.02 Formula (I)

where nH represents a refractive index of the hardcoat layer; nS represents a refractive index of the surface layer; and nC represents a refractive index of the cellulose acylate film other than the surface layer.

(2) The hardcoat film as described in item (1) above,

wherein the inorganic oxide fine particles contained in the surface layer include inorganic oxide fine particles of a metal selected from Al, Ti, Zr, Sb, Zn, Sn and In, and

an average particle diameter of the inorganic oxide fine particles is from 1 to 100 nm.

(3) A method for producing a hardcoat film, the hardcoat film including:

a cellulose acylate film containing at least a base layer and a surface layer; and

a hardcoat layer disposed at a surface layer side of the cellulose acylate film,

wherein the surface layer contains inorganic oxide fine particles and a cellulose acylate,

the surface layer has a refractive index of from 1.49 to 1.56 and an average film thickness of from 50 to 130 nm,

the hardcoat film satisfies formula (I):

0.98<(nH×nC)^{1/2}/nS<1.02 Formula (I)

where nH represents a refractive index of the hardcoat layer; nS represents a refractive index of the surface layer; and nC represents a refractive index of the cellulose acylate film other than the surface layer, and

the cellulose acylate film is produced by a co-casting method.

(4) The method for producing the hardcoat film as described in item (3) above,

wherein the inorganic oxide fine particles contained in the surface layer include inorganic oxide fine particles of a metal selected from Al, Ti, Zr, Sb, Zn, Sn and In, and

an average particle diameter of the inorganic oxide fine particles is from 1 to 100 nm.

(5) An antireflection film, including:

the hardcoat film as described in item (1) or (2) above; and

a layer disposed at an outermost surface of the hardcoat film, the layer having a refractive index lower than that of the hardcoat layer.

(6) A polarizing plate, including:

a polarizer; and

protective films disposed at both sides of the polarizer,

wherein at least one of the protective films is the hardcoat film as described in item (1) or (2), or the antireflection film as described in item (5) above.

(7) A display device, including:

the hardcoat film as described in item (1) or (2), the antireflection film as described in item (5) or the polarizing plate s described in item (6) at a surface of the display device.

### BRIEF DESCRIPTION OF THE DRAWINGS

FIG. 1 shows a cross-sectional view showing one example of the layer structure of a transparent support.

FIG. 2 shows a cross-sectional view showing another example of the layer structure of a transparent support.

FIG. 3 shows a view showing a solution film-forming apparatus using a casting band.

FIG. 4 shows a view showing a solution film-forming apparatus using a casting drum.

FIG. 5 shows a view showing a casting die for film-forming a single-layer film, which is used in a sequential casting method.

FIG. 6 shows a view showing a multi-manifold type co-casting die.

FIG. 7 shows a view showing a feed-block type co-casting die.

### DETAILED DESCRIPTION OF THE INVENTION

The best mode for carrying out the present invention is described in detail below, but the present invention is not limited thereto.

The hardcoat film of the present invention is a hardcoat film comprising a cellulose acylate film composed of at least a base layer and a surface layer and having a hardcoat layer on the surface layer side, wherein the surface layer contains an inorganic oxide fine particle and a cellulose acylate, the refractive index layer of the surface layer is from 1.49 to 1.56, the average film thickness of the surface layer is from 50 to 130 nm, and assuming that the refractive index of the hardcoat layer is nH, the refractive index of the surface layer is nS and the refractive index of the cellulose acylate film other than the surface layer is nC, the relationship of the following formula (I) is satisfied:

0.98<(nH×nC)^{1/2}/nS<1.02 Formula (I):

The production method of a hardcoat film of the present invention is a method for producing a hardcoat film comprising a cellulose acylate film composed of at least a base layer and a surface layer and having a hardcoat layer on the surface layer side, wherein the cellulose acylate film composed of at least a base layer and a surface layer is a cellulose acylate film produced by a co-casting method, the surface layer contains an inorganic oxide fine particle and a cellulose acylate, the refractive index layer of the surface layer is from 1.49 to 1.56, the average film thickness of the surface layer is from 50 to 130 nm, and assuming that the refractive index of the hardcoat layer is nH, the refractive index of the surface layer is nS and the refractive index of the cellulose acylate film other than the surface layer is nC, the relationship of the following formula (I) is satisfied:

0.98<(nH×nC)^{1/2}/nS<1.02 Formula (I):

The construction of the hardcoat film of the present invention is described in detail below.

### [Cellulose Acylate Film]

### (Construction of Cellulose Acylate Film)

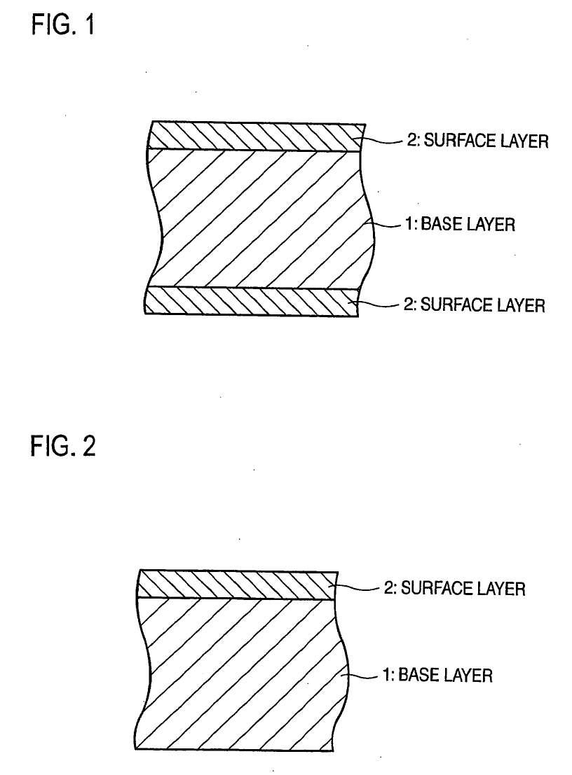

The cellulose acylate film for use in the present invention has a multilayer structure composed of at least a base layer and a surface layer, and the surface layer contains at least a cellulose acylate and an inorganic oxide fine particle. The surface layer may be stacked only on one side of the base layer or may be stacked on both sides of the base layer. That is, one embodiment is, as shown in FIG. 1, a three-layer structure composed of a base layer 1 and surface layers 2 stacked on both surfaces thereof, and another embodiment is, as shown in FIG. 2, a two-layer structure composed of a base layer 1 and a surface layer 2 stacked on one surface thereof. In the present invention, a two-layer embodiment where a surface layer is formed only on the side having a hardcoat layer is preferred. Furthermore, the surface layer is stacked on a surface of the cellulose acylate film, and other layers may be stacked between the base layer and the surface layer.

The average film thickness of the surface layer of the cellulose acylate film for use in the present invention is from 50 to 130 nm, preferably from 80 to 100 nm. By setting the average film thickness of the surface layer to this range, interference of lights effectively takes place in the visible light region, so that reflection at the interference and in turn, the interference unevenness can be suppressed. The average film thickness of the surface layer is determined by observing the cross-section of the cellulose acylate film by TEM (transmission electron microscope) and calculated as an average value by measuring the film thickness randomly at 10 points.

The film thickness of the base layer of the cellulose acylate film is preferably from 20 to 200 μm, more preferably from 30 to 120 μm.

### (Cellulose Acylate)

Examples of the cellulose that is a raw material of the cellulose acylate film include cotton linter, kenaf and wood pulp (e.g., hardwood pulp, softwood pulp). A cellulose acylate obtained by refining and esterifying any raw material cellulose may be used and depending on the case, a mixture thereof may be used.

In the present invention, the cellulose acylate means a carboxylic acid ester having an acyl group having total carbon number of 2 to 22.

The acyl group having a carbon number of 2 to 22 in the cellulose acylate for use in the present invention is not particularly limited and may be an aliphatic acyl group or an aromatic acyl group. Examples of the cellulose acylate include an alkyl carbonyl ester of cellulose, an alkenyl carbonyl ester of cellulose, a cycloalkylcarbonyl ester of cellulose, an aromatic carbonyl ester of cellulose, and an aromatic alkylcarbonyl ester of cellulose, and these esters each may further have a substituted group. Preferred examples of the acyl group include an acetyl group, a propionyl group, a butanoyl group, a pentanoyl, a heptanoyl group, a hexanoyl group, an octanoyl group, a cyclohexanecarbonyl group, an adamantanecarbonyl group, a phenylacetyl group, a benzoyl group, a naphthylcarbonyl group, a (meth)acryloyl group and a cinnamoyl group. Among these acyl groups, more preferred are propionyl, butanoyl, pentanoyl, hexanoyl, cyclohexanecarbonyl, phenylacetyl, benzoyl and naphthylcarbonyl.

The synthesis method of the cellulose acylate is described in detail in JIII Journal of Technical Disclosure, No. 2001-1745, page 9 (issued on Mar. 15, 2001 by Japan Institute of Invention and Innovation).

The cellulose acylate suitably used in the present invention is preferably a cellulose acylate where the substitution degrees to the hydroxyl group of cellulose satisfy the following formulae (1) and (2):

2.3≦SA′+SB′≦3.0 Formula (1):

0≦SA′≦3.0 Formula (2):

In the formulae above, SA′ represents a substitution degree of the acetyl group substituted to the hydrogen atom of the hydroxyl group in the cellulose, and SB′ represents a substitution degree of the acyl group having a carbon number of 3 to 22 substituted to the hydrogen atom of the hydroxyl group in the cellulose.

The β-1,4-bonded glucose unit constituting the cellulose has a free hydroxyl group at the 2-position, 3-position and 6-position. The cellulose acylate is a polymer where these hydroxyl groups are partially or entirely esterified by an acyl group. The acyl substitution degree means a ratio in which the cellulose is esterified at each of the 2-position, 3-position and 6-position (100% esterification at each position corresponds to a substitution degree of 1). In the present invention, the sum total (SA′+SB′) of the substitution degrees of SA′ and SB′ is preferably from 2.6 to 3.0, more preferably from 2.80 to 3.00. Also, SA′ is preferably from 1.4 to 3.0, more preferably from 2.3 to 2.9.

At the same time, the substitution degree preferably satisfies the following formula (3):

0≦(substitution degree of SB″)≦1.2 Formula (3):

In the formula above, SB″ represents an acyl group having a carbon number of 3 or 4 substituted to the hydrogen atom of the hydroxyl group in the cellulose.

In SB″, the substituent to the hydroxyl group at the 6-position preferably occupies 28% or more, more preferably 30% or more, still more preferably 31% or more, yet still more preferably 32% or more. The preferred cellulose acylate film also includes a cellulose acylate film where the sum total of the substitution degrees of SA′ and SB″ at the 6-position of the cellulose acylate is 0.8 or more, more preferably 0.85 or more, still more preferably 0.90 or more. With such a cellulose acylate film, a solution having preferred solubility can be produced and in particular, a good solution can be produced in a chlorine-free organic solvent.

The substitution degree is determined by calculation after measuring the bonding degree of a fatty acid bonded to the hydroxyl group in the cellulose. As for the measuring method, the bonding degree may be measured in accordance with ASTM D-817-91 and ASTM D-817-96. Also, the substitution state of the acyl group to the hydroxyl group is measured by a ¹³C-NMR method.

The cellulose acylate film is preferably composed of a cellulose acylate in which the polymer components constituting the film substantially satisfy formulae (1) and (2). The “substantially” means 55 mass % or more (preferably 70 mass % or more, more preferably 80 mass % or more) of all polymer components. One cellulose acylate may be used alone, or two or more kinds of cellulose acylates may be used in combination.

The polymerization degree of the cellulose acylate that is preferably used in the present invention is, in terms of the viscosity average polymerization degree, from 200 to 700, preferably from 230 to 550, more preferably from 230 to 350, still more preferably from 240 to 320. The viscosity average polymerization degree can be measured by the limiting viscosity method of Uda, et al. (Kazuo Uda and Hideo Saito, JOURNAL OF THE SOCIETY OF FIBER SCIENCE AND TECHNOLOGY, JAPAN, Vol. 18, No. 1, pp. 105-120 (1962)). Furthermore, this is described in detail in JP-A-9-95538.

The number average molecular weight Mn of the cellulose acylate is preferably from 7×10⁴ to 25×10⁴, more preferably from 8×10⁴ to 15×10⁴. The ratio Mw/Mn to the mass average molecular weight Mw of the cellulose acylate is preferably from 1.0 to 5.0, more preferably from 1.0 to 3.0. The average molecular weight and molecular weight distribution of the cellulose acylate can be measured using a high-performance liquid chromatography. From the results obtained, Mn and Mw are calculated and then, Mw/Mn can be calculated.

The cellulose acylate film for use in the present invention is preferably a film containing at least one cellulose acylate satisfying formulae (1) and (2) and at least one plasticizer (preferably a plasticizer described later, where the octanol/water partition coefficient (logP value) is between 0 and 10).

### (Inorganic Oxide Fine Particle)

In the present invention, the surface layer of the cellulose acylate film contains inorganic fine particles. Addition of inorganic oxide fine particles to the surface layer enables realizing a desired refractive index and obtaining an interference unevenness-preventing layer with good adherence.

The inorganic fine particles include an oxide of at least one metal selected from zirconium, titanium, aluminum, indium, zinc, tin and antimony.

Specific examples of the inorganic oxide fine particles include ZrO₂, TiO₂, Al₂O₃, In₂O₃, ZnO, SnO₂, Sb₂O₃, ITO and ATO. In addition, BaSO₄, CaCO₃, talc, kaolin or the like may also be used in combination. Above all, in view of refractive index, ZrO₂ or TiO₂ (in particular, a rutile type) is particularly preferred as the inorganic oxide fine particles.

The amount of the inorganic fine particles added to the surface layer of the cellulose acylate film varies depending on the refractive index of the cellulose acylate film, the refractive index of the hardcoat layer described later, and the refractive index of the inorganic oxide fine particles but is adjusted such that the refractive index of the surface layer of the cellulose acylate film becomes from 1.49 to 1.56. For example, the added amount is preferably from 1 to 70 mass % based on the entire solid content. In the case of a ZrO₂ particles, the added amount is preferably from 1 to 60 mass %, more preferably from 2 to 50 mass %, and in the case of a TiO₂ (rutile type) particles, the added amount is preferably from 0.1 to 25 mass %, more preferably from 1 to 18 mass %. By the addition in the amount above, the surface layer can be adjusted to a desired refractive index. Incidentally, the refractive index of the surface layer can be measured by an Abbe refractometer (manufactured by Atago Co., Ltd.) and in the present invention, the refractive index at the wavelength of sodium D line is employed.

As for the average particle diameter of the inorganic oxide fine particles used in the present invention, the inorganic oxide fine particles are preferably dispersed as finely as possible in a dispersion medium, and the mass average diameter is from 1 to 100 nm, preferably from 3 to 50 nm. When the average particle diameter of the inorganic oxide fine particle is 100 nm or less, the transparency of the film is not impaired and this is preferred, and when it is 1 nm or more, the stability of the fine particles is not deteriorated and this is preferred. The particle diameter of the inorganic fine particles can be measured by a nano-particle diameter distribution measuring apparatus “SALD-7100” manufactured by Shimadzu Corporation.

The specific surface area of the inorganic oxide fine particles is preferably from 10 to 400 m²/g, more preferably from 20 to 200 m²/g, and most preferably from 30 to 150 m²/g. The specific surface area is measured by a flow-type specific surface area automatic analyzer (“FlowSorb” III 2310) manufactured by Shimadzu Corporation.

### (Electrically Conductive Particle)

In the cellulose acylate film of the present invention, various electrically conductive particles may be used for imparting electrical conductivity. A hardcoat film/antireflection film having electrical conductivity advantageously exerts excellent dust resistance when disposed on the outermost surface of an image display device. The layer having electrical conductivity may be either the base layer or the surface layer, but the surface layer is preferred, because the layer is a thin film and electrical conductivity can be imparted by the addition of a small amount of electrically conductive particles.

The electrically conductive particles are preferably formed from an oxide or nitride of a metal. Examples of the metal oxide or nitride include tin oxide, indium oxide, zinc oxide and titanium nitride. Among these, tin oxide and indium oxide are preferred. The electrically conductive inorganic particles may include such a metal oxide or nitride as the main component and further contain other elements. The main component means a component having a largest content (mass %) among the components constituting the particles. Examples of the other elements include Ti, Zr, Sn, Sb, Cu, Fe, Mn, Pb, Cd, As, Cr, Hg, Zn, Al, Mg, Si, P, S, B, Nb, In, V and a halogen atom. In order to raise the electrical conductivity of tin oxide and indium oxide, Sb, P, B, Nb, In, V or a halogen atom is preferably added. Sb-containing tin oxide (ATO) and Sn-containing indium oxide (ITO) are particularly preferred. The proportion of Sb in ATO is preferably 3 to 20 mass %. The proportion of Sn in ITO is preferably 5 to 20 mass %.

The electrically conductive inorganic particles may be subjected to a surface treatment. The surface treatment is performed using an inorganic compound or an organic compound. Examples of the inorganic compound for use in the surface treatment include alumina and silica. A silica treatment is particularly preferred. Examples of the organic compound for use in the surface treatment include polyol, alkanolamine, stearic acid, a silane coupling agent and a titanate coupling agent. The silane coupling agent is most preferred. Two or more kinds of surface treatments may be performed in combination.

The shape of the electrically conductive inorganic particles is preferably a rice-grain shape, a spherical shape, a cubic shape, a spindle shape or an indefinite shape. Also, two or more kinds of electrically conductive particles may be used in combination in a specific layer or in the form of a film.

The electrically conductive inorganic particles can be used in the state of a dispersion for the formation of an antistatic layer.

### (Plasticizer)

The plasticizer for use in the present invention is a component added for imparting flexibility to the cellulose acylate film and enhancing the dimensional stability and moisture resistance. The preferred plasticizer includes a plasticizer which has a boiling point of 200° C. or more and is liquid at 25° C. or which is a solid having a melting point of 25 to 250° C., more preferably a plasticizer which has a boiling point of 250° C. or more and is liquid at 25° C. or which is a solid having a melting point of 25 to 200° C. In the case where the plasticizer is a liquid, the purification thereof is usually performed by distillation under reduced pressure, but a higher vacuum is more preferred and the plasticizer for use in the present invention is preferably a compound having a vapor pressure at 200° C. of 1,333 Pa or less, more preferably 667 Pa or less, still more preferably from 1 to 133 Pa.

As regards the plasticizer which is preferably added, for example, a phosphoric acid ester, a carboxylic acid ester or a polyol ester each having physical properties in the above-described ranges is used. Examples of the phosphoric acid ester include triphenyl phosphate, tricresyl phosphate, cresyl diphenyl phosphate, octyl diphenyl phosphate, diphenylbiphenyl phosphate, trioctyl phosphate and tributyl phosphate.

Representative examples of the carboxylic acid ester include a phthalic acid ester and a citric acid ester. Examples of the phthalic acid ester include dimethyl phthalate, diethyl phthalate, dibutyl phthalate, dioctyl phthalate, diphenyl phthalate and diethyl hexyl phthalate. Examples of the citric acid ester include O-acetyl triethyl citrate, O-acetyl tributyl citrate, acetyl triethyl citrate and acetyl tributyl citrate. These preferred plasticizers are a liquid at 25° C. except for TPP (melting point: about 50° C.) and have a boiling point of 250° C. or more.

Other examples of the carboxylic acid ester include butyl oleate, methyl acetyl ricinoleate, dibutyl sebacate and various trimellitic acid esters. Examples of the glycolic acid ester include triacetin, tributyrin, butyl phthalyl butyl glycolate, ethyl phthalyl ethyl glycolate, methyl phthalyl ethyl glycolate, butyl phthalyl butyl glycolate, methyl phthalyl methyl glycolate, propyl phthalyl propyl glycolate, butyl phthalyl butyl glycolate and octyl phthalyl octyl glycolate.

In addition, plasticizers described, for example, in JP-A-5-194788, JP-A-60-250053, JP-A-4-227941, JP-A-6-16869, JP-A-5-271471, JP-A-7-286068, JP-A-5-5047, JP-A-11-80381, JP-A-7-20317, JP-A-8-57879, JP-A-10-152568 and JP-A-10-120824 may also be preferably used. In these patent publications, not only examples of the plasticizer but also preferred utilization methods or properties of the plasticizer are abundantly described, and these may be preferably employed also in the present invention.

Other preferred examples of the plasticizer include (di)pentaerythritol esters described in JP-A-11-124445, glycerol esters described in JP-A-11-246704, diglycerol esters described in JP-A-2000-63560, citric acid esters described in JP-A-11-92574, substituted phenylphosphoric acid esters described in JP-A-11-90946, and ester compounds containing an aromatic ring and a cyclohexane ring described in JP-A-2003-165868.

Furthermore, in the present invention, a plasticizer having an octanol/water partition coefficient (logP value) between 0 and 10 is preferably used in particular. A plasticizer in this range is preferred, because when the logP value of the compound is 10 or less, compatibility with cellulose acylate is good and the film is free from troubles such as white turbidity or powdery bloom and when the logP value is 0 or more, the hydrophilicity is not excessively high and a problem such as worsening of the water resistance of the cellulose acylate film is hardly caused. The logP value is more preferably between 1 and 8, still more preferably between 2 and 7.

The octanol/water partition coefficient (logP value) can be measured by a shake flask method described in JIS (Japanese Industrial Standards) Z7260-107 (2000). In place of the actual measurement, the octanol/water partition coefficient (logP value) can also be estimated by a chemically computational method or an empirical method. Preferred examples of the computational method include the Crippen's fragmentation method [see, J. Chem. Inf. Comput. Sci., Vol. 27, page 21 (1987)], the Viswanadhan's fragmentation method [see, J. Chem. Inf. Comput. Sci., Vol. 29, page 163 (1989)], and the Broto's fragmentation method [see, Eur. J. Med. Chem.-Chim. Theor., Vol. 19, page 71 (1984)]. Above all, the Crippen's fragmentation method is more preferred. In the case where the logP value of a certain compound varies depending on the measuring method or calculating method, whether the compound is within the range of the present invention or not is preferably judged by the Crippen's fragmentation method.

A polymer plasticizer containing a resin component having a molecular weight of 1,000 to 100,000 is also preferably used. Examples thereof include a polyester and/or a polyether described in JP-A-2002-22956, a polyester ether, a polyester urethane and a polyester described in JP-A-5-197073, a copolyester ether described in JP-A-2-292342, and an epoxy resin and a novolak resin described in JP-A-2002-146044.

One of these plasticizers may be used alone, or two or more kinds thereof may be mixed and used. The amount of the plasticizer added is preferably from 2 to 30 parts by mass, more preferably from 5 to 20 parts by mass, per 100 parts by mass of the cellulose acylate in each layer.

### (Ultraviolet Absorber)

In the cellulose acylate film, an ultraviolet absorber is preferably further added so as to enhance the light resistance of the film itself or prevent deterioration of a polarizing plate or an image display member such as liquid crystal compound of a liquid crystal display device.

The ultraviolet absorber preferably has excellent ability of absorbing ultraviolet light at a wavelength of 370 nm or less from the standpoint of preventing deterioration of the liquid crystal and preferably exhibits as little absorption as possible for visible light at a wavelength of 400 nm or more in view of good image display property. In particular, the transmittance at 370 nm is preferably 20% or less, more preferably 10% or less, still more preferably 5% or less. Examples of such an ultraviolet absorber include, but are not limited to, an oxybenzophenone-based compound, a benzotriazole-based compound, a salicylic acid ester-based compound, a benzophenone-based compound, a cyanoacrylate-based compound, a nickel complex salt-based compound, and the above-described polymer ultraviolet absorbing compound containing an ultraviolet absorbing group. Two or more kinds of ultraviolet absorbers may be used.

The ultraviolet absorber may be added to the dope (a cellulose acylate solution for forming a cellulose acylate film) after dissolving it in an organic solvent such as alcohol, methylene chloride and dioxolane or may be directly added to the dope composition. An ultraviolet absorber like an inorganic powder, which does not dissolve in an organic solvent, is dispersed in a mixture of an organic solvent and a cellulose ester by using a dissolver or a sand mill and then added to the dope.

In the present invention, the amount of the ultraviolet absorber used is from 0.1 to 5.0 parts by mass, preferably from 0.5 to 2.0 parts by mass, more preferably from 0.8 to 2.0 parts by mass, per 100 parts by mass of the cellulose acylate in each layer.

### (Other Additives)

Furthermore, in the cellulose acylate film of the present invention, other various additives (for example, a deterioration inhibitor (e.g., antioxidant, peroxide decomposing agent, radical inhibitor, metal inactivating agent, acid scavenger, amine), an optical anisotropy controlling agent, a release agent, an antistatic agent and an infrared absorber) according to usage may be added in each preparation step. Such an additive may be either a solid or an oily product. That is, the melting point or boiling point thereof is not particularly limited. As for the infrared absorber, those described, for example, in JP-A-2001-194522 may be used.

These additives may be added at any stage in the process of preparing a dope (a cellulose acylate solution for forming a cellulose acylate film), or a step of adding the additives to prepare the dope may be added to the final preparation stage of the dope preparation process. The amount of each material added is not particularly limited as long as its function can be exerted. In the case where the cellulose acylate film is composed of multiple layers, the kind or amount added of the additive may differ among respective layers. This is a conventionally known technique described, for example, in JP-A-2001-151902. As for these additives including the ultraviolet absorber, the materials described in detail in JIII Journal of Technical Disclosure, No. 2001-1745, pp. 16-22 (issued on Mar. 15, 2001 by Japan Institute of Invention and Innovation) are preferably used.

Such an additive is preferably used in an appropriate amount within the range from 0.001 to 20 mass % based on the solid content.

### (Solvent)

The organic solvent in which the cellulose acylate for use in the present invention is dissolved is described below. The organic solvent used includes conventionally known organic solvents and, for example, a solvent having a dissolution parameter of 17 to 22 is preferred. The dissolution parameter indicates a dissolution parameter described, for example, in J. Brandrup, E. H., et al., Polymer Handbook, 4th ed., VII/671 to VII/714. Examples thereof include a chloride of lower aliphatic hydrocarbon, a lower aliphatic alcohol, a ketone having a carbon atom number of 3 to 12, an ester having a carbon atom number of 3 to 12, an ether having a carbon atom number of 3 to 12, aliphatic hydrocarbons having a carbon atom number of 5 to 8, aromatic hydrocarbons having a carbon number of 6 to 12, and fluoroalcohols (for example, compounds described in JP-A-8-143709, paragraph and JP-A-11-60807, paragraph [0037]).

The cellulose acylate film for use in the present invention is preferably produced from a cellulose acylate solution where a cellulose acylate is dissolved in an organic solvent to a concentration of 10 to 30 mass %, more preferably from 13 to 27 mass %, still more preferably from 15 to 25 mass %. The cellulose acylate solution may be prepared to such a cellulose acylate concentration by a method of preparing the solution to have a predetermined concentration at the stage of dissolving the cellulose acylate, a method of previously producing a low-concentration solution (for example, in a concentration of 9 to 14 mass %) and then preparing it into a solution having a predetermined high concentration in the condensation step described later, or a method of previously preparing a high-concentration cellulose acylate solution and then adding various additives to obtain a cellulose acylate solution having a predetermined low concentration. There is no problem in particular as long as the cellulose acylate solution concentration of the present invention is achieved by any of these methods.

### (Preparation of Dope)

In the preparation of the cellulose acylate solution (dope) for use in the present invention, the dissolution method is not particularly limited as described above, and the dope is prepared by a room-temperature dissolution method, a cooling dissolution method, a high-temperature dissolution method or a combination thereof. As regards these methods, the preparation method of a cellulose acylate solution is described, for example, in JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388. The techniques described in these patent publications regarding the method of dissolving the cellulose acylate in an organic solvent can be appropriately applied also to the present invention within the scope of the present invention. The dope is prepared by a method described in detail in these patent publications and, in particular, as for the non-chlorine type solvent system, the dope is prepared by the method described in detail in JIII Journal of Technical Disclosure, No. 2001-1745 supra, pp. 22-25. The dope solution of cellulose acylate for use in the present invention is usually further subjected to solution condensation and filtration, and these are described in detail similarly in JIII Journal of Technical Disclosure, No. 2001-1745 supra, page 25. Incidentally, in the case of dissolving the cellulose acylate at a high temperature, the temperature is in most cases not lower than the boiling point of the organic solvent used and in this case, the dissolution is performed in a pressurized state.

In the cellulose acylate solution for use in the present invention, the viscosity and dynamic storage modulus of the solution each is preferably in a specific range. The static non-Newtonian viscosity n* (Pa·sec) at 40° C. and the storage modulus G′ (Pa) at 5° C. are determined by subjecting 1 mL of a sample solution to a measurement using a rheometer (CLS 500) with a steel cone (both manufactured by TA Instruments) having a diameter of 4 cm/2° under the measurement conditions of varying the temperature at 2° C./min in a range from 40° C. to −10° C. in Oscillation Step/Temperature Ramp. The measurement is started after previously keeping the sample solution at a measurement initiating temperature until the liquid temperature becomes constant. In the present invention, it is preferred that the viscosity at 40° C. is from 1 to 300 Pa·sec and at the same time, the dynamic storage modulus at −5° C. is from 10,000 to 1,000,000 Pa. More preferably, the viscosity at 40° C. is from 1 to 200 Pa·sec and at the same time, the dynamic storage modulus at −5° C. is from 30,000 to 500,000 Pa.

### [Production Method of Cellulose Acylate Film]

In producing the cellulose acylate film for use in the present invention, a method of casting and stacking layers, such as co-casting (simultaneous multilayer casting), sequential casting and coating, can be used. In the case of producing the cellulose acylate film by a co-casting method or a sequential casting method, a dope for each layer is first prepared.

The co-casting method is a casting method where respective layers are simultaneously cast by extruding dopes from a casting geeser of simultaneously extruding dopes for respective layers (three or more layers) on a casting support (band or drum) through separate slits or the like, and the stack is separated from the support at an appropriate time and dried to form a film.

The sequential casting method is a casting method where a dope for casting a first layer is extruded and cast on a casting support from a casting geeser, after drying or not drying it, a dope for casing a second layer is cast and extruded thereon from the casting geeser, dopes for third and subsequent layers are sequentially cast and stacked in the same manner, and the stack is separated from the support at an appropriate time and dried to form a film.

The coating method in general is a method where a base layer film is formed by a solution film-forming method, a coating solution for forming a surface layer is prepared, and the coating solution is coated on both surfaces of the film one by one or simultaneously by using an appropriate coating machine and dried to form a film having a stack structure.

Of these co-casting method, sequential casting method and coating method, any method may be used for the production of the cellulose acylate film of the present invention. However, in general, the coating method requires a large drying load after coating, and the sequential casting method involves a complicated process and hardly allows the film to maintain its planarity, whereas in the co-casting method, the process is simple, the productivity is high, and the film planarity can be relatively easily obtained. Therefore, the cellulose acylate film is preferably produced by the co-casting method.

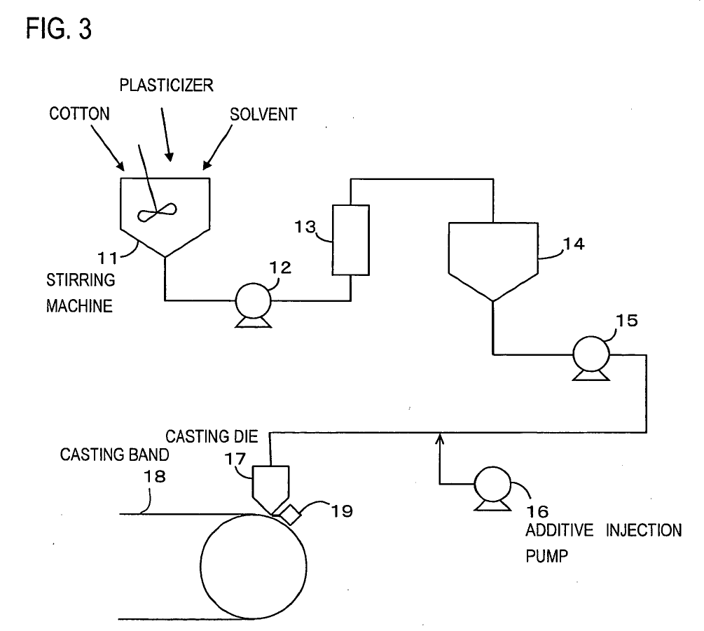

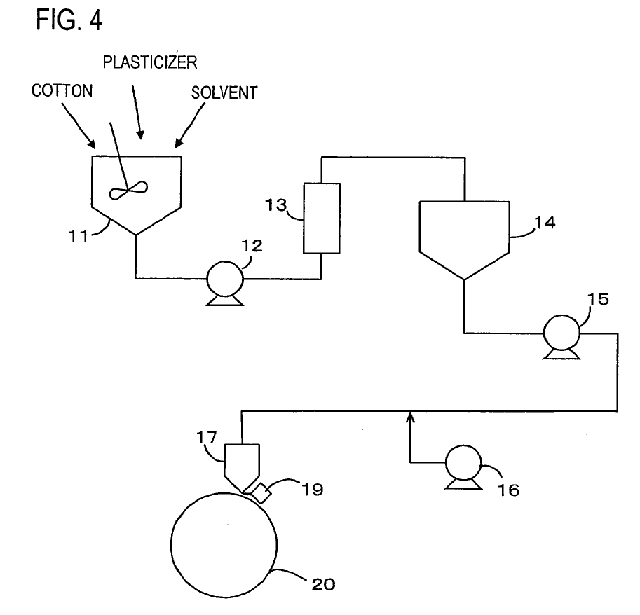

The apparatus for producing the cellulose acylate film for use in the present invention may be a solution film-forming apparatus using a casting band with the surface being mirror-processed, or a solution film-forming apparatus using a casting drum. FIG. 3 shows a solution film-forming apparatus using a casting band, and FIG. 4 shows a solution film-forming apparatus using a casting drum.

In the band-type solution film-forming apparatus shown in FIGS. 3, 11 is a stirring machine into which cotton, a plasticizer and a solvent are charged. The stirring machine 11 is connected to a casting die 17 through a transfer pump 12, a filtration device 13, a stock tank 14, a casting liquid-feed pump 15, and an additive injection pump 16 for adding fine particles, a dye, an ultraviolet absorber (UV agent) and the like. Below the casting die 17, a casting band 18 and a reduced pressure chamber 19 are provided.

In the drum-type solution film-forming apparatus shown in FIGS. 4, 20 is a casting drum and this is provided in place of the casting band 18 in the band-type solution film-forming apparatus. Incidentally, the stirring machine 11, the transfer pump 12, the filtration device 13, the stock tank 14, the casting liquid-feed pump 15, the additive injection pump 16 and the casting die 17 each has the same construction as above.

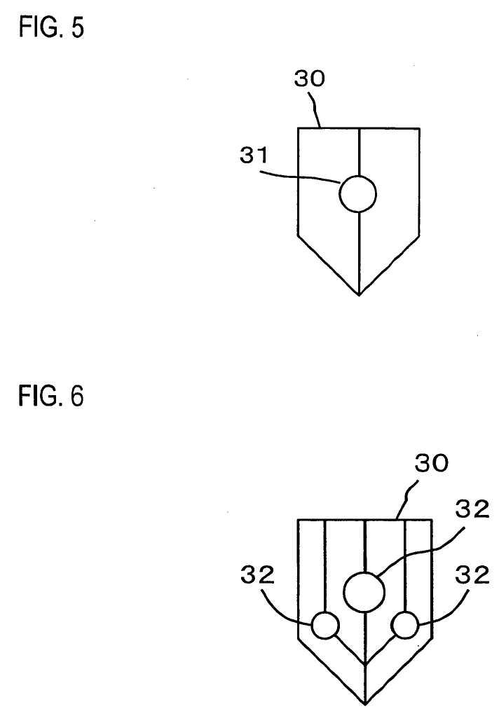

As for the casting die, those shown in FIGS. 5, 6 and 7 may be used.

FIG. 5 is a casting die for film-forming a single-layer film, which is used in the sequential casting method, and in this casting die 30, one manifold 31 is formed.

FIG. 6 is a multi-manifold type co-casting die, and this co-casting die 30, where three manifolds 32 are formed, enables film-formation of a film having a three-layer construction.

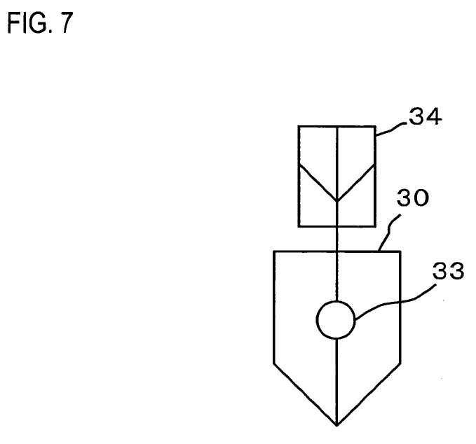

FIG. 7 is a feed-block type co-casting die, and in this co-casting die 30, not only a manifold 33 is formed but also a feed block 34 is provided, where a dope made to comprise a plurality of layers (in FIG. 7, three layers) after confluence through the feed block 34 is cast.

In these casting dies, a coat hunger die is used, but the die is not limited thereto and may be a die having other shapes, such as T-die.

### [Properties of Cellulose Acylate Film]

The cellulose acylate film for use in the present invention, which is suitably used as a transparent protective film for a polarizer or as a transparent protective film working out to a support of an antireflection film, preferably has the following properties.

### (Mechanical Properties of Film)

The curl value in the width direction of the transparent protective film is preferably from −7/m to +7/m. In the case of a long and broad transparent protective film, when the curl value in the width direction of a transparent protective film is in the range above, this is preferred because handling failure or breaking of the film does not occur, the intense contact of the film with a conveying roll at the edge or center part of the film less incurs generation of dusts or attachment of extraneous materials to the film, and the frequency of point defects or coating streaks on the polarizing plate of the present invention does not exceed the tolerance. In addition, lamination to a polarizing film can be advantageously prevented from entering of an air bubble.

The curl value can be measured according to the measuring method (ANSI/ASCPH 1.29-1985) prescribed by the American National Standards Institute.

The residual solvent amount of the cellulose acylate film is preferably 1.5 mass % or less, because curling can be suppressed. The residual solvent amount is more preferably from 0.01 to 1.0 mass %. This is considered because when the residual solvent amount at the film formation by the above-described solvent casting film-forming method is made small, a reduced free volume results and acts as a main factor for the effect of suppressing the curling.

The tear strength of the cellulose acylate film, in terms of tear strength based on the tear strength test (Ermendorf Tear Method) of JIS K7128-2:1998, is preferably 2 g or more from the standpoint that the film strength can be satisfactorily maintained even with the later-described film thickness (from 20 to 200 μm). The tear strength is more preferably from 5 to 25 g, still more preferably from 6 to 25 g. Also, the tear strength in terms of 60 μm is preferably 8 g or more, more preferably from 8 to 15 g. Specifically, a sample piece of 50 mm×64 mm is subjected to moisture conditioning under the conditions of 25° C. and 65% RH for 2 hours and then, the tear strength can be measured using a light-load tear strength tester.

The scratch strength is preferably 2 g or more, more preferably 5 g or more, still more preferably 10 g or more. Within this range, the scratch resistance and handleability of the film surface are maintained without problem. The cellulose acylate film surface is scratched with a sapphire needle having a conical apex angle of 90° and a tip radius of 0.25 m, and the scratch strength can be evaluated by the load (g) when the scratch mark is recognized with an eye.

### (Hygroscopic Expansion Coefficient of Film)

The cellulose acylate film preferably has a hygroscopic expansion coefficient of 30×10⁻⁵/% RH or less. The hygroscopic expansion coefficient is more preferably 15×10⁻⁵/% RH or less, still more preferably 10×10⁻⁵/% RH or less. The hygroscopic expansion coefficient is preferably smaller but is usually a value of 1.0×10⁻⁵/% RH or more. The hygroscopic expansion coefficient indicates the variation in the length of a sample when the relative humidity is varied at a constant temperature. By this adjustment of the hygroscopic expansion coefficient, the cellulose acylate film can have good durability or in the case of a polarizing plate where an optically compensatory film is stacked, a frame-like increase of transmittance, that is, light leakage due to strain, can be prevented while maintaining the optically compensating function.

The measuring method of the hygroscopic expansion coefficient is described below. A sample of 5 mm in width and 20 mm in length is cut out from the produced cellulose acylate film and in the state of one end being fixed, the sample is suspended in an atmosphere of 25° C. and 20% RH (R0). A weight of 0.5 g is hung at another end and after the sample is left standing for 10 minutes, the length (H0) is measured. Next, while keeping the temperature at 25° C., the humidity is changed to 80% RH (R1) and after the sample is left standing for 24 hours, the length (H1) is measured. The hygroscopic expansion coefficient is calculated according to the following formula (4). The measurement is performed for 10 units of the same sample, and the average value is employed.

Hygroscopic expansion coefficient(/% RH)={(H1−H0)/H0}/(R1−R0) Formula (4):

In order to reduce the dimensional change due to moisture absorption of the produced cellulose acylate film, for example, addition of the above-described plasticizer or fine particles is effective. A plasticizer having a bulky and hydrophobic polycyclic alicyclic structure in the molecule is considered to work effectively. A method of decreasing the residual solvent amount in the cellulose acylate film and thereby making small the free volume is also effective. Specifically, the drying is preferably performed under the conditions of giving a residual solvent amount in a range from 0.001 to 1.5 mass %, more preferably from 0.01 to 1.0 mass %, based on the cellulose acylate film.

### (Equilibrium Moisture Content of Film)

As for the equilibrium moisture content of the cellulose acylate film, when the cellulose acylate film is used as a transparent protective film of a polarizing plate, irrespective of the film thickness, the equilibrium moisture content at 25° C. and 80% RH is preferably from 0 to 4 mass %, more preferably from 0.1 to 3.5 mass %, still more preferably from 1 to 3 mass %, so as not to impair adhesive property to a water-soluble polymer such as polyvinyl alcohol. When the equilibrium moisture content is not more than the upper limit above, in using the cellulose acylate film as a transparent protective film of a polarizing plate, dependency of the retardation on the humidity change does not become excessively large and this is preferred.

The moisture content is determined by a method of measuring a sample of 7 mm×35 mm of the cellulose acylate film of the present invention by a Karl Fischer method by using a water content meter “CA-03” and a sample drying device “VA-05” [both manufactured by Mitsubishi Chemical Corporation]. The moisture content is calculated by dividing the amount (g) of water by the mass (g) of the sample.

### (Moisture Permeability of Film)

The moisture permeability of the cellulose acylate film is determined by measuring the film according to JIS Z-0208 of JIS Standards under the conditions of a temperature of 60° C. and a humidity of 95% RH and converting the obtained value in terms of the film thickness of 80 μm. The moisture permeability is preferably from 400 to 2,000 g/m²·24 h, more preferably from 500 to 1,800 g/m²·24 h, still more preferably from 600 to 1,600 g/m²·24 h. When the moisture permeability is not more than the upper limit above, the humidity dependency of the retardation value of the film scarcely exceeds 0.5 nm/% RH in terms of the absolute value and this is preferred. Also in the case of stacking an optically anisotropic layer on the cellulose acylate film of the present invention to produce an optically compensatory film, the humidity dependency of the Re value and Rth value does not exceed 0.5 nm/% RH in terms of the absolute value and this is advantageous. Furthermore, when a polarizing plate with such an optically compensatory film is incorporated into a liquid crystal display device, troubles such as change of color tint or reduction of viewing angle are scarcely caused, which is preferred. On the other hand, when the moisture permeability is not less than the lower limit above, at the time of laminating the cellulose acylate film to, for example, both surfaces of a polarizing film to produce a polarizing plate, troubles such as occurrence of adhesion failure as a result of the adhesive being hindered from drying by the cellulose acylate film are less brought about and this is advantageous.

The moisture permeability is small when the thickness of the cellulose acylate film is large, and the moisture permeability is large when the film thickness is small. Therefore, the moisture permeability of a sample having any film thickness needs to be converted by setting the standard to 80 μm. The conversion of film thickness is performed as (moisture permeability in terms of 80 μm=measured moisture permeability×measured film thickness μm/80 μm).

As for the measuring method of moisture permeability, a method described in “Measurement of Amount of Water Vapor Permeated (mass method, thermometer method, water vapor pressure method, adsorption amount method)” of Kobunshi Jikken Koza 4, Kobunshi no Bussei II (Polymer Experiment Lecture 4, Physical Properties II of Polymers), pp. 285-294, Kyoritsu Shuppan can be applied. Specifically, a cellulose acylate film sample of 70 mmφ is humidity-conditioned at 25° C.-90% RH or 60° C.-95% RH for 24 hours, the amount (g/m²) of water per unit area is calculated according to JIS Z-0208 by a moisture permeability tester [“KK-709007” manufactured by Toyo Seiki Seisaku-Sho, Ltd.], and the moisture permeability is determined by moisture permeability=mass after humidity conditioning—mass before humidity conditioning.

The hardcoat layer stacked on the cellulose acylate film is described below.

### [Hardcoat Layer]

In the hardcoat film of the present invention, a hardcoat layer is provided on one surface of the cellulose acylate film (transparent support) for imparting physical strength to the cellulose acylate film.

An antireflection film (hardcoat film with an antireflection function) is constructed preferably by providing a low refractive index layer lower in the refractive index than the hardcoat layer thereon (preferably on the outermost surface), more preferably by providing a medium refractive index layer and a high refractive index layer between the hardcoat layer and the low refractive index.

The hardcoat layer may be composed of a stack of two or more layers.

In view of optical design for obtaining an antireflection film, the refractive index of the hardcoat layer in the present invention is preferably from 1.48 to 1.65.

Also, assuming that the refractive index of the hardcoat layer is nH, the refractive index of the surface layer is nS and the refractive index of the cellulose acylate film other than the surface layer is nC, a relationship of the following formula (I) is preferably established.

0.98<(nH×nC)^{1/2}/nS<1.02. Formula (1):

When the refractive index of each layer is in the range of formula (I) and at the same time, the film thickness of the surface layer is from 50 to 130 nm, interference unevenness is not visually recognized, which is preferred. It is presumed that when the layers satisfy the above-described relationship, the reflected light at the hardcoat layer/surface layer interface and the reflected light at the surface layer/base layer interface cancel each other and interference of these two reflected lights with the reflected light at the air/hardcoat layer interface is suppressed, as a result, the interference unevenness is reduced.

From the standpoint of imparting sufficient durability and impact resistance to the film, the film thickness of the hardcoat layer is preferably on the order of 3 to 15 μm, preferably from 4 to 15 μm, more preferably from 5 to 14 μm, and most preferably from 6 to 13 μm. In the measurement of the film thickness of the hardcoat layer, the cross-section of the produced hardcoat film is photographed at a magnification of 5,000 by an electron microscope “S-3400N” {manufactured by Hitachi High-Technologies Corp.}, the film thickness of the hardcoat layer is measured randomly at 10 points, and an average value is derived therefrom.

The strength of the hardcoat layer is preferably 2H or more, more preferably 3H or more, and most preferably 4H or more, in the pencil hardness test.

Furthermore, in the Taber test according to JIS K5400, the abrasion loss of the specimen between before and after test is preferably smaller.

The hardcoat layer is preferably formed through a crosslinking or polymerization reaction of an ionizing radiation-curable compound. For example, a coating composition containing an ionizing radiation-curable polyfunctional monomer or polyfunctional oligomer is coated on a transparent support, and a crosslinking or polymerization reaction of the polyfunctional monomer or polyfunctional oligomer is brought about, whereby the hardcoat layer can be formed.

The functional group in the ionizing radiation-curable polyfunctional monomer or polyfunctional oligomer is preferably a photo-, electron beam- or radiation-polymerizable functional group, more preferably a photopolymerizable functional group.

Examples of the photopolymerizable functional group include an unsaturated polymerizable functional group such as (meth)acryloyl group, vinyl group, styryl group and allyl group. Among these, a (meth)acryloyl group is preferred.

### [Low Refractive Index Layer]

In the present invention, a low refractive index layer can be provided on the outer side of the hardcoat layer, that is, on the remoter side from the cellulose acylate film. By having a low refractive index layer, an antireflection function can be imparted to the hardcoat film. The refractive index of the low refractive index layer is preferably set to be lower than the refractive index of the hardcoat layer. If the refractive index difference between the low refractive index layer and the hardcoat layer is too small, the antireflectivity is liable to decrease, whereas if it is excessively large, the color tint of reflected light tends to be intensified. The refractive index difference between the low refractive index layer and the hardcoat layer is preferably from 0.01 to 0.30, more preferably from 0.05 to 0.20.

The low refractive index layer can be formed using a low refractive index material. As for the low refractive index material, a low refractive index binder may be used. The low refractive index layer may also be formed by adding fine particles to the binder.

The low refractive index binder which can be preferably used is a fluorine-containing copolymer. The fluorine-containing copolymer preferably contains a constitutional unit derived from a fluorine-containing vinyl monomer and a constitutional unit for imparting crosslinking property.

### (Fluorine-Containing Copolymer)

Examples of the fluorine-containing vinyl monomer mainly constituting the fluorine-containing copolymer include fluoroolefins (e.g., fluoroethylene, vinylidene fluoride, tetrafluoroethylene, hexafluoropropylene), partially or completely fluorinated alkyl ester derivatives of (meth)acrylic acid {e.g., “VISCOAT 6FM” (trade name) produced by Osaka Organic Chemical Industry Ltd., “R-2020” (trade name) produced by Daikin Industries, Ltd.}, and completely or partially fluorinated vinyl ethers. Among these, perfluoroolefins are preferred, and hexafluoropropylene is more preferred in view of refractive index, solubility, transparency, availability and the like.

When the compositional ratio of the fluorine-containing vinyl monomer is increased, the refractive index can be lowered, but the film strength tends to decrease. In the present invention, the fluorine-containing vinyl monomer is preferably introduced such that the copolymer has a fluorine content of 20 to 60 mass %, more preferably from 25 to 55 mass %, still more preferably from 30 to 50 mass %.

The constitutional unit for imparting crosslinking reactivity mainly includes the following units (A), (B) and (C):

(A): a constitutional unit obtained by the polymerization of a monomer previously having a self-crosslinking functional group within the molecule, such as glycidyl (meth)acrylate and glycidyl vinyl ether,

(B): a constitutional unit obtained by the polymerization of a monomer having a carboxyl group, a hydroxyl group, an amino group, a sulfo group or the like {for example, a (meth)acrylic acid, a methylol (meth)acrylate, a hydroxyalkyl (meth)acrylate, an allyl acrylate, a hydroxyethyl vinyl ether, a hydroxybutyl vinyl ether, a maleic acid and a crotonic acid}, and

(C): a constitutional unit obtained by reacting a compound having a group capable of reacting with the functional group of (A) or (B) above within the molecule and separately having a crosslinking functional group, with the constitutional unit of (A) or (B) above (for example, a constitutional unit which can be synthesized by a technique such as a method of causing an acrylic acid chloride to act on a hydroxyl group).

In the constitutional unit of (C), the crosslinking functional group is preferably a photopolymerizable group. Examples of the photopolymerizable group include a (meth)acryloyl group, an alkenyl group, a cinnamoyl group, a cinnamylideneacetyl group, a benzalacetophenone group, a styrylpyridine group, an α-phenylmaleimide group, a phenyl-azide group, a sulfonylazide group, a carbonylazide group, a diazo group, an o-quinonediazide group, a furylacryloyl group, a coumarin group, a pyrone group, an anthracene group, a benzophenone group, a stilbene group, a dithiocarbamate group, a xanthate group, a 1,2,3-thiadiazole group, a cyclopropene group and an azadioxabicyclo group. The constitutional unit may contain only one of these groups or may contain two or more thereof. Among these, a (meth)acryloyl group and a cinnamoyl group are preferred, and a (meth)acryloyl group is more preferred.

The specific method for preparing the photopolymerizable group-containing copolymer includes, but is not limited to, the following methods:

a. a method of reacting a (meth)acrylic acid chloride with a crosslinking functional group-containing copolymer having a hydroxyl group, and effecting esterification,

b. a method of reacting a (meth)acrylic acid ester having an isocyanate group with a crosslinking functional group-containing copolymer having a hydroxyl group, and effecting urethanization,

c. a method of reacting a (meth)acrylic acid with a crosslinking functional group-containing copolymer having an epoxy group, and effecting esterification, and

d. a method of reacting a (meth)acrylic acid ester having an epoxy group with a crosslinking functional group-containing copolymer having a carboxyl group, and effecting esterification.

The amount of the photopolymerizable group introduced can be arbitrarily controlled and from the standpoint of, for example, stabilizing the coating film surface state, reducing the surface state failure when inorganic particles are present together, or enhancing the film strength, a carboxyl group, a hydroxyl group or the like may be allowed to remain.

In the present invention, the amount of the constitutional unit for imparting crosslinking property introduced into the copolymer is preferably from 10 to 50 mol %, more preferably from 15 to 45 mol %, still more preferably from 20 to 40 mol %.

In the copolymer useful for the low refractive index layer of the present invention, in addition to the repeating unit derived from the fluorine-containing vinyl monomer and the constitutional unit for imparting crosslinking property, other vinyl monomers may be appropriately copolymerized from various viewpoints such as adherence to substrate, Tg (contributing to hardness of the coating film) of polymer, solubility in solvent, transparency, slipperiness, dust resistance and antifouling property. A plurality of these vinyl monomers may be used in combination according to the purpose, and these monomers are preferably introduced in a total amount of 0 to 65 mol %, more preferably from 0 to 40 mol %, still more preferably from 0 to 30 mol %, based on the copolymer.

The vinyl monomer unit which can be used in combination is not particularly limited, and examples thereof include olefins (e.g., ethylene, propylene, isoprene, vinyl chloride, vinylidene chloride), acrylic acid esters (e.g., methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethylstyrene, p-methoxystyrene), vinyl ethers (e.g., methyl vinyl ether, ethyl vinyl ether, cyclohexyl vinyl ether, hydroxyethyl vinyl ether, hydroxybutyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethylacrylamide, N-tert-butylacrylamide, N-cyclohexylacrylamide), methacrylamides (e.g., N,N-dimethylmethacrylamide), and acrylonitrile.

The fluorine-containing copolymer particularly useful in the present invention is a random copolymer of a perfluoroolefin and a vinyl ether or vinyl ester. In particular, the fluorine-containing polymer preferably has a group capable of undergoing a crosslinking reaction by itself {for example, a radical reactive group such as (meth)acryloyl group, or a ring-opening polymerizable group such as epoxy group and oxetanyl group}. The crosslinking reactive group-containing polymerization unit preferably occupies from 5 to 70 mmol %, more preferably from 30 to 60 mol %, in all polymerization units of the polymer. Preferred examples of the polymer include those described in JP-A-2002-243907, JP-A-2002-372601, JP-A-2003-26732, JP-A-2003-222702, JP-A-2003-294911, JP-A-2003-329804, JP-A-2004-4444 and JP-A-2004-45462.

Also, in the fluorine-containing copolymer useful in the present invention, a polysiloxane structure is preferably introduced for the purpose of imparting antifouling property. The method for introducing a polysiloxane structure is not limited but is preferably, for example, a method of introducing a polysiloxane block copolymerization component by using a silicone macroazo initiator described in JP-A-6-93100, JP-A-11-189621, JP-A-11-228631 and JP-A-2000-313709, or a method of introducing a polysiloxane graft copolymerization component by using a silicone macromer described in JP-A-2-251555 and JP-A-2-308806. The particularly preferred compound includes polymers in Examples 1, 2 and 3 of JP-A-11-189621, and Copolymers A-2 and A-3 of JP-A-2-251555. The content of the polysiloxane component in the polymer is preferably from 0.5 to 10 mass %/, more preferably from 1 to 5 mass %.

The molecular weight of the copolymer which can be preferably used in the present invention is, in terms of the mass average molecular weight, preferably 5,000 or more, more preferably from 10,000 to 500,000, and most preferably from 15,000 to 200,000. By using polymers differing in the average molecular weight in combination, the surface state of coating film or the scratch resistance may be improved.

With the copolymer above, as descried in JP-A-10-25388 and JP-A-2000-17028, a curing agent having a polymerizable unsaturated group may be appropriately used in combination. A combination use with a compound having a fluorine-containing polyfunctional polymerizable unsaturated group described in JP-A-2002-145952 is also preferred. Examples of the compound having a polyfunctional polymerizable unsaturated group include the polyfunctional monomers described above for the hardcoat layer. These compounds are preferred because the effect by the combination use on the improvement of scratch resistance is great particularly when a compound having a polymerizable unsaturated group is used in the copolymer body.

The refractive index of the low refractive index layer is preferably from 1.20 to 1.46, more preferably from 1.25 to 1.42, still more preferably from 1.30 to 1.38. The thickness of the low refractive index layer is preferably from 50 to 150 nm, more preferably from 70 to 120 nm.

### (Fine Particles Contained in Low Refractive Index Layer)

The fine particles which can be preferably used in the low refractive index layer of the present invention is described below.

The coated amount of the fine particles contained in the low refractive index layer is preferably from 1 to 100 Mg/m², more preferably from 5 to 80 mg/m², still more preferably from 1 to 70 mg/m². When the coated amount of the fine particles is not less than this lower limit, a clear effect of improving scratch resistance appears, and when it is not more than the upper limit above, a trouble such as worsening of outer appearance or integrated reflectance due to creation of fine irregularities on the low refractive index layer surface does not arise and this is preferred. The fine particles are contained in the low refractive index layer and therefore, preferably have a low refractive index.

Specifically, the fine particles contained in the low refractive index layer are preferably inorganic fine, hollow inorganic fine particles or hollow organic resin fine particles, each having a low refractive index, more preferably hollow inorganic fine particles. Examples of the inorganic fine particles include silica fine particles and hollow silica fine particles. The average particle diameter of these fine particles is preferably from 30 to 100%, more preferably from 30 to 80%, still more preferably from 35 to 70%, of the thickness of the low refractive index layer. In other words, when the thickness of the low refractive index layer is 100 nm, the particle diameter of the fine particles is preferably from 30 to 100 nm, more preferably from 30 to 80 nm, still more preferably from 35 to 70 nm.

When the particle diameter of the (hollow) silica fine particles is not less than the lower limit above, a clear effect of improving scratch resistance appears, and when it is not more than the above-described upper limit, a trouble such as reduction of outer appearance or integrated reflectance due to creation of fine irregularities on the low refractive index layer surface does not arise and this is preferred.

The (hollow) silica fine particles may be either crystalline or amorphous and may be monodisperse particles or aggregated particles (in this case, the secondary particle diameter is preferably from 15 to 150% of the thickness of the low refractive index layer). Also, a plurality of kinds (two or more kinds) of particles (differing in the kind or particle diameter) may be used. The shape of the particles is most preferably spherical but even if indefinite, there arises no problem.

In order to reduce the refractive index of the low refractive index layer, it is particularly preferred to use hollow silica fine particles. The refractive index of the hollow silica fine particles is preferably from 1.17 to 1.40, more preferably from 1.17 to 1.35, still more preferably from 1.17 to 1.30. The refractive index used here indicates a refractive index of the particles as a whole and does not mean a refractive index of only silica in the outer shell forming the hollow silica particles. At this time, assuming that the radius of the cavity inside the particle is rᵢ and the radius of the outer shell of the particle is r₀, the porosity x is calculated according the following formula (5):

x=(4πrᵢ³/3)/(4πr₀³/3)×100 Formula (5):

The porosity x is preferably from 10 to 60%, more preferably from 20 to 60%, and most preferably from 30 to 60%. If the hollow silica particles are intended to have a lower refractive index and a higher porosity, the thickness of the outer shell becomes small and the strength as a particle decreases. Therefore, in view of scratch resistance, particles having a refractive index of less than 1.17 are difficult to use. Here, the refractive index of the hollow silica particles is measured by an Abbe refractometer {manufactured by Atago Co., Ltd.}.

In the present invention, from the standpoint of enhancing the antifouling property, it is preferred to reduce the surface free energy of the low refractive index layer surface. Specifically, a fluorine-containing compound or a compound having a polysiloxane structure is preferably used in the low refractive index layer.

As for the additive having a polysiloxane structure, a reactive group-containing polysiloxane {for example, “KF-100T”, “X-22-169AS”, “KF-102”, “X-22-3701IE”, “X-22-164B”, “X-22-5002”, “X-22-173B”, “X-22-174D”, “X-22-167B”, “X-22-161AS” (trade names), all produced by Shin-Etsu Chemical Co., Ltd.; “AK-5”, “AK-30” and “AK-32” (trade names), all produced by Toagosei Co., Ltd.; and “SILAPLANE FM0725” and “SILAPLANE FM0721” (trade names), both produced by Chisso Corporation} is also preferably added. Furthermore, silicone-based compounds shown in Tables 2 and 3 of JP-A-2003-112383 may also be preferably used. Such a polysiloxane is preferably added in an amount of 0.1 to 10 mass %, more preferably from 1 to 5 mass %, based on the entire solid content of the low refractive index layer.

### [Production Method of Antireflection Film]

The antireflection film of the present invention may be formed by the following method, but the present invention is not limited thereto.

### (Preparation of Coating Solution)

First, a coating solution containing components for forming each layer is prepared. At this time, an increase in the percentage of water content in the coating solution can be prevented by minimizing the volatilization volume of the solvent. The percentage of water content in the coating solution is preferably 5% or less, more preferably 2% or less. The volatilization volume of the solvent can be suppressed, for example, by raising the closeness at the stirring after the materials are charged into a tank or minimizing the contact area of the coating solution with air at the liquid transfer operation. Also, a device for reducing the percentage of water content in the coating solution may be provided during, before or after the coating.

### (Filtration)

The coating solution for use in coating is preferably filtered before it is coated. The filtration is preferably preformed using a filter having as small a pore size as possible within the range not allowing for elimination of the components in the coating solution. In the filtration, a filter having an absolute filtration accuracy of 0.1 to 50 μm is preferably used. A filter having an absolute filtration accuracy of 0.1 to 40 μm is more preferred. The filter thickness is preferably from 0.1 to 10 mm, more preferably from 0.2 to 2 mm. In this case, the filtration is preferably performed under a filtration pressure of 1.5 MPa or less, more preferably 1.0 MPa or less, still more preferably 0.2 MPa or less.

The filter member of filtration is not particularly limited as long as it does not affect the coating solution. Specific examples thereof are the same as those of the filtration member described above for the wet dispersion of an inorganic compound. It is also preferred to ultrasonically disperse the filtered coating solution immediately before coating and assist in defoaming or keeping the dispersed state of the dispersion.

### (Treatment Before Coating)

The transparent support for use in the present invention is preferably subjected to a heat treatment for correcting the base deformation or to a surface treatment for improving the coatability or adhesion to the coated layer and then coated. The specific method for the surface treatment includes a corona discharge treatment, a glow discharge treatment, a flame treatment, an acid treatment, an alkali treatment and an ultraviolet irradiation treatment. It is also preferred to provide an undercoat layer as described in JP-A-7-333433.

Furthermore, a dedusting step is preferably performed as a pre-step before coating. The dedusting method for use in this step includes a dry dedusting method, for example, a method of pressing a nonwoven fabric, a blade or the like against the film surface described in JP-A-59-150571; a method of blowing air having a high cleanliness at a high speed to separate off attached matters from the film surface and sucking these matters through a proximate suction port described in JP-A-10-309553; and a method of blowing compressed air under ultrasonic vibration to separate off attached matters and sucking these matters described in JP-A-7-333613 {for example, NEW ULTRA-CLEANER manufactured by Shinko Co., Ltd.}. Also, a wet dedusting method may be used, such as a method of introducing the film into a cleaning bath and separating off attached matters by using an ultrasonic vibrator; a method of supplying a cleaning solution to the film and blowing air at a high speed, followed by sucking described in JP-B-49-13020; and a method of continuously rubbing the web with a liquid-moistened roll and then cleaning the web by jetting a liquid onto the rubbed face described in JP-A-2001-38306. Among these dedusting methods, an ultrasonic dedusting method and a wet dedusting method are preferred in view of the dedusting effect.

Before performing such a dedusting step, the static electricity on the transparent support is preferably destaticized for elevating the dedusting efficiency and suppressing attachment of dirt. As for the destaticizing method, an ionizer of corona discharge type, an ionizer of light irradiation type (e.g., UV, soft X-ray), and the like may be used. The voltage charged on the transparent support before and after dedusting and coating is preferably 1,000 V or less, more preferably 300 V or less, still more preferably 100 V or less.

From the standpoint of maintaining the planarity of the film, the transparent support such as cellulose acylate film in these treatments is preferably kept at a temperature not more than Tg of the polymer constituting the film, in the case of a cellulose acylate film, at 150° C. or less.

As in the case of using the antireflection film of the present invention for a protective film of a polarizing plate, when a cellulose acylate film that is a preferred transparent support of the antireflection film is adhered to a polarizing film, an acid or alkali treatment, that is, a saponification treatment for cellulose acylate, is preferably performed in consideration of adhesion to the polarizing film.

In view of adhesion, the surface energy of the cellulose acylate film as the transparent support is preferably 55 mN/m or more, more preferably from 60 to 75 mN/m. The surface energy can be adjusted by the above-described surface treatment.

### (Coating)

Each layer of the film of the present invention can be formed by the following coating methods, but the present invention is not limited to these methods. Known methods such as dip coating method, air knife coating method, curtain coating method, roller coating method, wire bar coating method, gravure coating method, extrusion coating method (die coating method) (see, U.S. Pat. No. 2,681,294 and International Publication No. 2005/123274, pamphlet), and microgravure coating method, are used. Among these, a microgravure coating method and a die coating method are preferred.

The microgravure coating method for use in the present invention is a coating method where a gravure roll having a diameter of about 10 to 100 mm, preferably from about 20 to 50 mm, and having a gravure pattern engraved on the entire circumference is disposed below the transparent support and while rotating the gravure roll in the direction reverse to the support-conveying direction, the surplus coating solution is scraped off from the surface of the gravure roll by a doctor blade, thereby allowing a constant amount of the coating solution to be transferred to and coated on the bottom surface of the support at the position where the top surface of the support is in a free state. A roll-form transparent support is continuously unrolled and on one side of the unrolled support, at least one layer out of at least an antiglare layer and a low refractive index layer containing a fluorine-containing olefin-based polymer can be coated by the microgravure coating method.

As for the coating conditions in the microgravure coating method, the number of lines in the gravure pattern engraved on the gravure roll is preferably from 50 to 800 lines/inch, more preferably from 100 to 300 lines/inch, the depth of the gravure pattern is preferably from 1 to 600 μm, more preferably from 5 to 200 μm, the rotation number of the gravure roll is preferably from 3 to 800 rpm, more preferably from 5 to 200 rpm, and the transparent support-conveying speed is preferably from 0.5 to 100 m/min, more preferably from 1 to 50 m/min.

In order to provide the film of the present invention with high productivity, an extrusion method (die coating method) is preferably used. In particular, coating can be preferably performed by the extrusion method described in JP-A-2006-122889.

The die coating method is a pre-weighing system and therefore, a stable film thickness can be easily ensured. Also, in this coating method, a coating solution in a low coated amount can be coated at a high speed with good film thickness stability. Such a coating solution may be coated by other coating methods, but a dip coating method inevitably involves vibration of the coating solution in a liquid-receiving tank, which readily leads to generation of stepwise unevenness. In a reverse roll coating method, stepwise unevenness is liable to occur due to eccentricity or deflection of the roll involved in the coating. Also, these coating methods are a post-weighing system and therefore, a stable film thickness can be hardly ensured. In view of productivity, the coating is preferably performed at a rate of 20 m/min or more by using the die coating method.

### (Drying)

After coating a layer on a transparent support directly or through other layers, the film of the present invention is preferably conveyed in the form of a web to a heated zone for drying the solvent.

As for the method of drying the solvent, various known techniques may be utilized. Specific examples thereof include the techniques described in JP-A-2001-286817, JP-A-2001-314798, JP-A-2003-126768, JP-A-2003-315505 and JP-A-2004-34002.

The temperature in the drying zone is preferably from 25 to 140° C., and it is preferred that the temperature in the first half of the drying zone is relatively low and the temperature in the second half is relatively high. However, the temperature is preferably not more than the temperature at which the components other than the solvent contained in the composition of the coating solution for each layer start volatilizing. For example, some of commercially available photoradical generators used in combination with an ultraviolet curable resin are volatilized by about several tens of percent within several minutes in warm air at 120° C., and some of monofunctional or bifunctional (meth)acrylic acid ester monomers or the like allow their volatilization to proceed in warm air at 100° C. In such a case, as described above, the drying zone temperature is preferably not more than the temperature at which the components other the solvent contained in the coating composition for each layer start volatilizing.

In order to prevent drying unevenness, the drying air after applying the coating solution for each layer on a transparent support is preferably blown at an air velocity of 0.01 to 2 m/sec on the coating film surface during the time where the solid content concentration of the coating solution is from 1 to 50%. Also, in the drying zone after applying the coating solution for each layer on a transparent support, the difference in the temperature between the support and the conveying roll in contact with the surface opposite the coating surface of the support is preferably set to fall in the range from 0 to 20° C., because drying unevenness due to uneven heat transfer on the conveying roll can be prevented.

### (Curing)

The antireflection film of the present invention after drying the solvent is passed in the form of a web through a zone for curing each coating film by the irradiation of ionizing radiation and/or under heat, whereby the coating film can be cured. The species of the ionizing radiation for use in the present invention is not particularly limited and according to the kind of the curable composition for forming a film, the radiation may be appropriately selected from ultraviolet ray, electron beam, near ultraviolet ray, visible light, near infrared ray, infrared ray, X-ray and the like, but ultraviolet ray and electron beam are preferred, and ultraviolet is more preferred in that the handling is easy and a high energy can be easily obtained.

As regards the light source for ultraviolet ray that photopolymerizes an ultraviolet-curable compound, any light source may be used as long as it emits an ultraviolet ray. Examples of the light source which can be used include a low-pressure mercury lamp, a medium-pressure mercury lamp, a high-pressure mercury lamp, an ultrahigh-pressure mercury lamp, a carbon arc lamp, a metal halide lamp and a xenon lamp. Also, an ArF excimer laser, a KrF excimer laser, an excimer lamp, a synchrotron radiation light and the like may be used. Among these, an ultrahigh-pressure mercury lamp, a high-pressure mercury lamp, a low-pressure mercury lamp, a carbon arc, a xenon arc and a metal halide lamp can be preferably used.

An electron beam may also be similarly used. Examples of the electron beam include electron beams having an energy of 50 to 1,000 keV, preferably from 100 to 300 keV, emitted from various electron beam accelerators such as Cockroft-Walton type, Van de Graff type, resonance transformer type, insulating core transformer type, linear type, dynamitron type and high frequency type.

The irradiation conditions vary depending on individual lamps, but the quantity of light irradiated is preferably 10 mJ/cm² or more, more preferably from 50 to 10,000 mJ/cm², still more preferably from 50 to 2,000 mJ/cm². At this time, the irradiation dose distribution in the web width direction is preferably, including both edges, from 50 to 100%, more preferably from 80 to 100%, based on the maximum irradiation dose in the center.

In the present invention, at least one layer out of layers stacked on the transparent support is preferably cured by a process of irradiating ionizing radiation and at the same time, irradiating the ionizing radiation in an atmosphere having an oxygen concentration of 1,000 ppm or less, preferably 500 ppm or less, more preferably 100 ppm or less, most preferably 50 ppm or less, for 0.5 seconds or more from the initiation of ionizing radiation irradiation in a state of the layer being heated to a film surface temperature of 50° C. or more.

It is also preferred that the layer is heated in an atmosphere having a low oxygen concentration simultaneously with and/or successively to the irradiation of ionizing radiation. In particular, the low refractive index layer which is an outermost layer and has a small film thickness is preferably cured by this method. The curing reaction is accelerated by the heat and a coating film excellent in the physical strength and chemical resistance can be formed.

The time for which the ionizing radiation is irradiated is preferably from 0.5 to 60 seconds, more preferably from 0.7 to 10 seconds. When the irradiation time is 0.5 seconds or more, the curing reaction can be completed and satisfactory curing can be performed. Also, maintenance of the low oxygen condition for a long time requires large-scale equipment and a large amount of inert gas such as nitrogen and therefore, the irradiation time is preferably 60 seconds or less.

As for the means to reduce the oxygen concentration to 1,000 ppm or less, replacement of the atmospheric air with another gas is preferred, and replacement with nitrogen (nitrogen purging) is more preferred.

When the conditions are set such that an inert gas is supplied to the ionizing radiation irradiation chamber (sometimes referred to as a “reaction chamber”) of performing the curing reaction by ionizing radiation and at the same time, slightly blown out to the web inlet side of the reaction chamber, not only the carry-over air associated with the web conveyance can be eliminated to effectively decrease the oxygen concentration in the reaction chamber but also the substantial oxygen concentration on the electrode surface greatly susceptible to curing inhibition by oxygen can be efficiently reduced. The direction to which the inert gas flows on the web inlet side of the reaction chamber can be controlled by adjusting the balance between air supply and air discharge in the reaction chamber. Blowing of an inert gas directly on the web surface is also preferred as the method for removing the carry-over air.

Furthermore, when a pre-chamber is provided before the reaction chamber and the oxygen on the web surface is previously eliminated, the curing can be allowed to proceed more efficiently. In order to efficiently use the inert gas, the gap between the side surface constituting the web inlet side of the ionizing radiation reaction chamber or pre-chamber and the web surface is preferably from 0.2 to 15 mm, more preferably from 0.2 to 10 mm, and most preferably from 0.2 to 5 mm. However, for continuously producing a web, the web needs to be joined and spliced and a method of laminating the webs by means of a bonding tape or the like is widely employed for joining. Therefore, when the gap between the inlet surface of the ionizing radiation reaction chamber or pre-chamber and the web is too small, there arises a problem that the bonding member such as bonding tape is hung up. To solve this problem, in the case of forming a narrow gap, at least a part of the inlet surface of the ionizing radiation reaction chamber or pr-chamber is preferably made movable, so that the gap can be enlarged for the joining thickness when the bonded part enters the chamber. This construction may be realized by a method where the inlet surface of the ionizing radiation reaction chamber or pre-chamber is made movable back and forth in the running direction and moved back and forth to enlarge the gap when the bonded part passes therethrough, or a method where the inlet surface of the ionizing radiation reaction chamber or pre-chamber is made movable perpendicularly to the web surface and moved vertically to enlarge the gap when the bonded part passes therethrough.

The ultraviolet ray may be irradiated every time when a plurality of layers constituting the antireflection film of the present invention each is formed, or may be irradiated after the layers are stacked. Alternatively, some of these layers may be irradiated in combination. In view of productivity, the ultraviolet ray is preferably irradiated after stacking multiple layers.

In the present invention, at least one layer stacked on the transparent support may be cured by irradiating ionizing radiation a plurality of times. In this case, the irradiation of ionizing radiation is preferably performed at least twice in continuous reaction chambers where the oxygen concentration does not exceed 1,000 ppm. By performing the irradiation of ionizing radiation a plurality of times in reaction chambers having the same low oxygen concentration, the reaction time necessary for curing can be effectively ensured. Particularly, in the case of increasing the production speed for high productivity, the ionizing radiation needs to be irradiated a plurality of time so as to ensure an ionizing radiation energy necessary for the curing reaction.

The curing percentage (100—percentage of residual functional group content) is preferably a certain value less than 100%, because when another layer is provided thereon and cured by ionizing radiation and/or heat, the curing percentage of the lower layer becomes higher than that before providing the upper layer and the adherence between the lower layer and the upper layer is improved.

### (Handling)

In order to continuously produce the antireflection film of the present invention, a step of continuously delivering a roll-like transparent support film, a step of coating and drying the coating solution, a step of curing the coating film, and a step of taking up the support film having thereon the cured layer are performed.

The support is continuously delivered from a roll-like transparent support to a clean room, static electricity charged to the support is removed by a destaticizing apparatus in the clean room, and extraneous materials adhering to the transparent support are then removed by a dedusting apparatus. Subsequently, a coating solution is coated on the support in a coating part disposed in the clean room, and the coated transparent support is conveyed to a drying room and dried.

The transparent support having thereon the dried coating layer is delivered from the drying room to a curing room, where the monomer contained in the coating layer is polymerized to effect curing. The transparent support having thereon the cured layer is further conveyed to a curing part, where the curing is completed, and the transparent support having thereon the completely cured layer is taken up into a roll.

The above-described steps may be performed every time when each layer is formed, or a plurality of coating part-drying room-curing part lines may be provided to continuously perform the formation of respective layers.

In producing the antireflection film of the present invention, it is preferred that in combination with the above-described microfiltration operation of the coating solution, the coating step in the coating part and the drying step in the drying room are performed in an atmosphere having high air cleanliness and dirt and dust on the transparent support film are sufficiently removed before performing the coating. The air cleanliness in the coating step and drying step is, according to the standard of air cleanliness in US Federal Standard 209E, preferably not lower than class 10 (the number of particles of 0.5 μm or more is 353 particles/m³ or less), more preferably not lower than class 1 (the number of particles of 0.5 μm or more is 35.5 particles/m³ or less). More preferably, the air cleanliness is high also in the parts other than the coating-drying steps, such as delivery part and take-up part.

### (Saponification Treatment)

In producing a polarizing plate by using the antireflection film of the present invention for one protective film out of two surface protective films of the polarizing film, the surface on the side to be laminated with the polarizing film is preferably hydrophilized to improve the adhesive property on the bonding surface.

### (a) Method by Dipping in Alkali Solution

This is a technique of dipping the film in an alkali solution under appropriate conditions to saponify all the surfaces having reactivity with an alkali on the entire film surface. This method requires no special equipment and is preferred in view of cost. The alkali solution is preferably an aqueous sodium hydroxide solution. The concentration is preferably from 0.5 to 3 mol/L, more preferably from 1 to 2 mol/L. The liquid temperature of the alkali solution is preferably from 30 to 75° C., more preferably from 40 to 60° C.

The combination of the saponification conditions is preferably a combination of relatively mild conditions but may be set according to the materials or construction of the film or the objective contact angle. The film after dipping in an alkali solution is preferably well washed with water or dipped in a dilute acid to neutralize the alkali component and not allow remaining of the alkali component in the film.

By applying a saponification treatment, the surface opposite the surface having the coating layer is hydrophilized. The protective film for a polarizing plate is used by adhering the hydrophilized surface of the transparent support to the polarizing film.

The hydrophilized surface is effective for improving the adhesive property to the adhesive layer comprising polyvinyl alcohol as the main component.

As for the saponification treatment, the contact angle for water on the transparent support surface opposite the surface having the coating layer is preferably lower in view of adhesion to the polarizing film, but, on the other hand, in the dipping method, the surface having the coating layer as well as the inside of the layer are damaged simultaneously by an alkali and therefore, it is important to select minimum necessary reaction conditions. In the case where the contact angle for water on the transparent support surface on the opposite side is used as the index for damage of each layer by an alkali, particularly when the transparent support is triacetyl cellulose, the contact angle is preferably from 10 to 50°, more preferably from 30 to 50°, still more preferably from 40 to 50°. A contact angle of 50° or less is preferred because no problem arises in the adhesion to the polarizing film, and a contact angle of 10° or more is preferred because the film is not so much damaged and the physical strength is not impaired.

### (b) Method by Coating of Alkali Solution

In order to avoid the damage of each layer in the dipping method, an alkali solution coating method where an alkali solution is coated only on the surface opposite the surface having the coating layer under appropriate conditions and the coated film is then heated, water-washed and dried, is preferably used. In this case, the “coating” means to contact an alkali solution or the like only with the surface to be saponified and includes spraying and contact with a belt or the like impregnated with the solution, other than coating.

When such a method is employed, equipment and step for coating an alkali solution are separately required and therefore, the cost is higher than in the dipping method of (a). However, since the alkali solution comes into contact only with the surface to be saponified, a layer using a material weak to an alkali solution can be provided on the opposite surface. For example, a vapor-deposition film or a sol-gel film is subject to various effects of an alkali solution, such as corrosion, dissolution and separation, and is not preferably provided in the case of dipping method, but in this coating method, such a film is not contacted with the solution and therefore, can be used without problem.

The saponification methods (a) and (b) both can be performed after unrolling a roll-like support and forming respective layers and therefore, the saponification step may be added after the film production process and performed in a series of operations. Furthermore, by continuously performing also a step of laminating a polarizing plate to a support unrolled similarly, the polarizing plate can be produced with higher efficiency than in the case of performing the same operations in the sheet-fed manner.

(c) Method of Performing Saponification Under Protection with Laminate Film

Similarly to (b) above, when the coating layer lacks the resistance against an alkali solution, a method of, after a final layer is formed, laminating a laminate film on the surface where the final layer is formed, then dipping the stack in an alkali solution to hydrophilize only the triacetyl cellulose surface opposite the surface where the final layer is formed, and thereafter peeling off the laminate film, may be employed. Also in this method, a hydrophilizing treatment enough as a polarizing plate protective film can be applied, without damaging the coating layer, only to the surface of the triacetyl cellulose film as the transparent support, which lies on the opposite side to the surface where the final layer is formed. Compared with the method (b), this method is advantageous in that a special apparatus for coating an alkali solution is not necessary, though the laminate film remains as a waste.

(d) Method by Dipping in Alkali Solution after Formation Up to Mid-Layer

In the case where the layers up to the underlying layer have resistance against an alkali solution but a layer thereon lacks the resistance against an alkali solution, a method of forming the layers up to the underlying layer, then dipping the stack in an alkali solution to hydrophilize both surfaces, and thereafter forming a layer thereon, may be employed. The production process becomes cumbersome but this method is advantageous in that, for example, in the case of a film composed of an antiglare layer and a low refractive index layer which is a fluorine-containing sol-gel film, when the layers have a hydrophilic group, the interlayer adhesion between the antiglare layer and the low refractive index layer is enhanced.

### (e) Method of Forming Coating Layer on Previously Saponified Triacetyl Cellulose Film

After previously saponifying a triacetyl cellulose film as the transparent support, for example, by dipping it in an alkali solution, a coating layer may be formed on either one surface directly or through other layers. In the case of performing the saponification by dipping the film in an alkali solution, the interlayer adhesion between the coating layer and the triacetyl cellulose surface hydrophilized by the saponification is sometimes worsened. This problem can be overcome by applying, after the saponification, a treatment such as corona discharge or glow discharge only to the surface where the coating layer is to be formed, thereby removing the hydrophilized surface, and then forming the coating layer. Also, in the case where the coating layer has a hydrophilic group, good interlayer adhesion may be obtained.

### [Polarizing Plate]

The antireflection film of the present invention may be used for either one or both of the protective films of a polarizing plate composed of a polarizing film and protective films disposed on both sides thereof, to provide a polarizing plate having antireflectivity.

While using the antireflection film of the present invention as one protective film, a normal cellulose acetate film may be used for the other protective film, but a cellulose acetate film produced by a solution film-forming method and stretched in the width direction of a rolled film form at a stretch ratio of 10 to 100% is preferably used for the other protective film.

Furthermore, in the polarizing plate of the present invention, it is also a preferred embodiment that one surface is the antireflection film of the present invention and the other protective film is an optically compensatory film having an optically anisotropic layer composed of a liquid crystalline compound.

### (Polarizer)

The polarizer (polarizing film) includes an iodine-based polarizing film, a dye-based polarizing film using a dichroic dye, and a polyene-based polarizing film. The iodine-based polarizing film and the dye-based polarizing film are generally produced using a polyvinyl alcohol-based film.

The polarizing film may be a known polarizing film or a polarizing film cut out from a lengthy polarizing film with the absorption axis of the polarizing film being neither parallel nor perpendicular to the longitudinal direction. The lengthy polarizing film with the absorption axis of the polarizing film being neither parallel nor perpendicular to the longitudinal direction is produced by the following method.

This polarizing film can be produced by a stretching method of stretching a continuously fed polymer film such as polyvinyl alcohol-based film to 1.1 to 20.0 times at least in the film width direction by applying a tension while holding both film edges with holding means, and bending the film travelling direction in a state of both film edges being held, under the condition of the difference in the longitudinal travel speed between the holding devices at both film edges being within 3%, such that the angle made by the film travelling direction at the outlet in the step of holding both film edges and the substantial stretching direction of the film is inclined at 20° to 70°. Particularly, a polarizing film produced by making an inclination angle of 45° is preferred in view of productivity.

The stretching method of a polymer film is described in detail in JP-A-2002-86554 (paragraphs [0020] to [0030]).

In the present invention, the slow axis of the transparent support or cellulose acetate film of the antireflection film and the transmission axis of the polarizing film are preferably arranged to run substantially in parallel.

### (Protective Film)

The moisture permeability of the protective film is important for the productivity of the polarizing plate. The polarizing film and the protective film are laminated together with an aqueous adhesive, and the solvent of this adhesive diffuses in the protective film and is thereby dried. As the moisture permeability of the protective film is higher, the drying rate and in turn the productivity are more increased, but if the moisture permeability is excessively high, moisture enters into the polarizing film depending on the environment (at high humidity) where the liquid crystal display device is used, and the polarizing ability deteriorates.

The moisture permeability of the protective film is determined, for example, by the thickness, free volume or hydrophilicity/hydrophobicity of the transparent support or polymer film (and polymerizable liquid crystal compound). In the case of using the antireflection film of the present invention as a protective film of the polarizing plate, the moisture permeability is preferably from 100 to 1,000 g/m²·24 hrs, more preferably from 300 to 700 g/m²·24 hrs.

In the case of film production, the thickness of the transparent support can be adjusted by the lip flow rate and the line speed or by stretching and compression. The moisture permeability varies depending on the main raw material used and therefore, can be adjusted to a preferred range by controlling the thickness.

In the case of film production, the free volume of the transparent support can be adjusted by the drying temperature and time. Also in this case, the moisture permeability varies depending on the main raw material used and therefore, can be adjusted to a preferred range by controlling the free volume.

The hydrophilicity/hydrophobicity of the transparent support can be adjusted by an additive. The moisture permeability can be raised by adding a hydrophilic additive to the above-described free volume and conversely, the moisture permeability can be reduced by adding a hydrophobic additive.

A polarizing plate having an optically compensating ability can be produced with high productivity at a low cost by independently controlling the moisture permeability.

### (Optically Compensatory Film)

It is also a preferred embodiment that out of two protective films of the polarizing film, the film other than the antireflection film of the present invention is an optically compensatory film having an optically compensatory layer containing an optically anisotropic layer. The optically compensatory film (phase difference film) can improve the viewing angle properties on a liquid crystal display screen.

The optically compensatory film may be a known optically compensatory film but from the standpoint of enlarging the viewing angle, the optically compensatory film described in JP-A-2001-100042 is preferred.

### <Use Mode of the Present Invention>

The antireflection film of the present invention is used for an image display device such as liquid crystal display (LCD), plasma display panel (PDP), electroluminescent display (ELD) and cathode ray tube display (CRT).

### [Liquid Crystal Display Device]

The antireflection film or polarizing plate of the present invention can be advantageously used for an image display device such as liquid crystal display and is preferably used as the outermost surface layer of the display.

In general, the liquid crystal display device has a liquid crystal cell and two polarizing plates disposed on both sides thereof, and the liquid crystal cell carries a liquid crystal between two electrode substrates. In some cases, one optically anisotropic layer is disposed between the liquid crystal cell and one polarizing plate, or two optically anisotropic layers are disposed, that is, one between the liquid crystal cell and one polarizing plate, and another between the liquid crystal cell and another polarizing plate.

The liquid crystal cell is preferably in TN mode, VA mode, OCB mode, IPS mode or ECB mode.

### (TN Mode)

In the TN-mode liquid crystal cell, rod-like liquid crystalline molecules are oriented substantially in the horizontal alignment at the time of not applying a voltage and furthermore, twisted at an angle of 60 to 120°.

The TN-mode liquid crystal cell is most frequently utilized as a color TFT liquid crystal display device and is described in many publications.

### (VA Mode)

In the VA-mode liquid crystal cell, rod-like liquid crystalline molecules are oriented substantially in the vertical alignment at the time of not applying a voltage.

The VA-mode liquid crystal cell includes:

(1) a VA-mode liquid crystal cell in a narrow sense where rod-like liquid crystalline molecules are oriented substantially in the vertical alignment at the time of not applying a voltage and oriented substantially in the horizontal alignment at the time of applying a voltage (described in JP-A-2-176625);

(2) an (MVA-mode) liquid crystal cell where the VA mode is modified into a multi-domain mode for enlarging the viewing angle (described in SID97, Digest of Tech. Papers (preprints), 28, 845 (1997));

(3) an (n-ASM-mode) liquid crystal cell where rod-like liquid crystalline molecules are oriented substantially in the vertical alignment at the time of not applying a voltage and oriented in the twisted multi-domain alignment at the time of applying a voltage (described in preprints of Nippon Ekisho Toronkai (Liquid Crystal Forum of Japan), 58-59 (1998)); and

(4) a SURVIVAL-mode liquid crystal cell (reported in LCD International 98).

### (OCB Mode)

The OCB-mode liquid crystal cell is a liquid crystal cell of bend alignment mode where rod-like liquid crystalline molecules are oriented substantially in the reverse direction (symmetrically) between upper portion and lower portion of the liquid crystal cell, and this is disclosed in U.S. Pat. Nos. 4,583,825 and 5,410,422. Since rod-like liquid crystalline molecules are symmetrically oriented between upper portion and lower portion of the liquid crystal cell, the liquid crystal cell of bend alignment mode has an optically self-compensating ability. Accordingly, this liquid crystal mode is called an OCB (optically compensatory bend) liquid crystal mode. The liquid crystal display device of bend alignment mode is advantageous in that the response speed is fast.

### (IPS Mode)

The IPS-mode liquid crystal cell is a system of switching a nematic liquid crystal by applying a transverse electric field thereto, and this is described in detail in Proc. IDRC (Asia Display 95), pp. 577-580 and ibid., pp. 707-710.

### (ECB Mode)

In the ECB-mode liquid crystal cell, rod-like liquid crystalline molecules are oriented substantially in the horizontal alignment at the time of not applying a voltage. The ECB mode is one of liquid crystal display modes having a simplest structure and is described in detail, for example, in JP-A-5-203946.

### [PDP]

The plasma display panel (PDP) is generally composed of a gas, a glass substrate, an electrode, an electrode lead material, a thick print material and a fluorescent material. As for the glass substrate, two sheets of front glass substrate and rear glass substrate are used. An electrode and an insulating layer are formed on the two glass substrates, and a fluorescent material layer is further formed on the rear glass substrate. The two glass substrates are assembled, and a gas is sealed therebetween.

The plasma display panel (PDP) is already available on the market. The plasma display panel is described in JP-A-5-205643 and JP-A-9-306366.

In some cases, a front panel is disposed on the front surface of the plasma display panel. The front panel preferably has sufficiently high strength for protecting the plasma display panel. The front panel may be disposed with spacing from the plasma display panel or may be laminated directly to the plasma display body. In an image display device like the plasma display panel, the hardcoat film or antireflection film of the present invention can be laminated directly to the display surface. In the case where a front panel is provided in front of the display, the antireflection film may be laminated to the front side (outer side) or back side (display side) of the front panel.

### [Touch Panel]

The hardcoat film or antireflection film of the present invention can be applied to a touch panel and the like described, for example, in JP-A-5-127822 and JP-A-2002-48913.

### [Organic EL Device]

The hardcoat film or antireflection film of the present invention can be used as a substrate (backing film) or a protective film of an organic EL device or the like.

In the case of using the hardcoat film or antireflection film of the present invention for an organic EL device or the like, the contents described, for example, in JP-A-11-335661, JP-A-11-335368, JP-A-2001-192651, JP-A-2001-192652, JP-A-2001-192653, JP-A-2001-335776, JP-A-2001-247859, JP-A-2001-181616, JP-A-2001-181617, JP-A-2002-181816, JP-A-2002-181617 and JP-A-2002-056976 may be applied. Furthermore, the contents described in each of JP-A-2001-148291, JP-A-2001-221916 and JP-A-2001-231443 are preferably used in combination.

### EXAMPLES

The present invention is described in greater detail below by referring to Examples and Comparative Examples. As regards the materials, amounts used, ratios, contents of treatment, procedures of treatment, and the like set forth in the following Examples, appropriate changes can be made without departing from the purport of the present invention. Accordingly, the scope of the present invention should not be construed as being limited to these Examples.

### [Production of Transparent Support]

A base layer dope and a surface layer dope were prepared according to the dope formulation shown in Table 1 and cast under the conditions shown in Table 2 to produce Transparent Supports 1 to 11. The transparent support was dried with hot air at 100° C. until the residual solvent amount became 10 mass %, and further dried with hot air at 140° C. for 10 minutes.

TABLE 1

| | | | Base Layer Dope | Surface Layer Dope | | | | |
|---|---|---|---|---|---|---|---|---|
| Composition | | | C-1 | S-1 | S-2 | S-3 | S-4 | S-5 |
| Cellulose triacetate concentration (mass %) | | | 17.0 | 15.6 | 14.5 | 14.8 | 14.8 | 14.8 |
| Solvent composition | Methylene chloride (mass %) | | 72.4 | 74.2 | 74.2 | 74.2 | 74.2 | 74.2 |
| | Methanol (mass %) | | 8.0 | 8.2 | 8.2 | 8.2 | 8.2 | 8.2 |
| Additive | Triphenyl phosphate (mass %) | | 2.6 | 0.47 | 0.44 | 0.44 | 0.44 | 0.44 |
| | Inorganic fine particle | ZrO₂ Fine particle | — | 1.47 | 2.56 | — | — | — |
| | (mass %) | TiO₂ Fine particle | — | — | — | 2.26 | 2.30 | 2.32 |

TABLE 2

| | | Dope Formulation | | Film Thickness (μm) | | Refractive Index | |
|---|---|---|---|---|---|---|---|
| | Casting Mode | Base Layer | Surface Layer | Base Layer | Surface Layer | Base Layer | Surface Layer |
| Transparent Support 1 | co-casting | C-1 | S-1 | 80 | 0.092 | 1.485 | 1.497 |
| Transparent Support 2 | co-casting | C-1 | S-2 | 40 | 0.091 | 1.485 | 1.507 |
| Transparent Support 3 | co-casting | C-1 | S-2 | 40 | 0.055 | 1.485 | 1.507 |
| Transparent Support 4 | co-casting | C-1 | S-2 | 40 | 0.04 | 1.485 | 1.507 |
| Transparent Support 5 | co-casting | C-1 | S-2 | 40 | 0.12 | 1.485 | 1.507 |
| Transparent Support 6 | co-casting | C-1 | S-2 | 40 | 0.14 | 1.485 | 1.507 |
| Transparent Support 7 | co-casting | C-1 | S-3 | 60 | 0.089 | 1.485 | 1.541 |
| Transparent Support 8 | co-casting | C-1 | S-4 | 60 | 0.089 | 1.485 | 1.564 |
| Transparent Support 9 | co-casting | C-1 | S-5 | 60 | 0.089 | 1.485 | 1.579 |
| Transparent Support 10 | single-layer | C-1 | — | 80 | — | 1.485 | — |
| | casting | | | | | | |
| Transparent Support 11 | single-layer | C-1 | — | 80 | — | 1.485 | — |
| | casting | | | | | | |

Details of the inorganic oxide fine particles in Table 1 are described below.

### TiO₂ Fine Particle:

Rutile-type titanium oxide fine particle (average particle diameter: 20 nm, produced by Ishihara Sangyo Kaisha Ltd.)

### ZrO₂ Fine Particle:

Zirconium oxide fine particle (average particle diameter: 40 nm, produced by Sumitomo Osaka Cement Co., Ltd.)

In the cellulose triacetate in Table 1, the acetyl substitution degree was 2.9, Mn was 160,000, and Mw/Mn was 1.8.

### [Preparation of Coating Solution for Hardcoat Layer]

The components shown below were charged into a mixing tank and after stirring, the resulting solution was filtered through a polypropylene-made filter having a pore size of 3 μm to prepare the coating solution.

### Formulation of Coating Solution (H-1) for Hardcoat Layer:

| | | |
|---|---|---|
| PET-30 | 24.25 | parts by mass |
| VISCOAT 360 | 24.25 | parts by mass |
| IRGACURE 127 | 1.5 | parts by mass |
| Methyl isobutyl ketone | 40.0 | parts by mass |
| Methyl ethyl ketone | 10.0 | parts by mass |

Here, PET-30, VISCOAT 360 and IRGACURE 127 are as follows.

### PET-30:

A mixture of pentaerythritol triacrylate and pentaerythritol tetraacrylate [produced by Nippon Kayaku Co., Ltd.].

### VISCOAT 360:

Ethylene oxide-modified trimethylolpropane triacrylate (produced by Osaka Organic Chemical Industry Ltd.)

### IRGACURE 127:

A photopolymerization initiator, produced by Ciba Specialty Chemicals Corp. Formulation of Coating Solution (H-2) for Hardcoat Layer:

| | |
|---|---|
| DPHA | 48.5 parts by mass |
| IRGACURE 184 | 1.5 parts by mass |
| Methyl isobutyl ketone | 40.0 parts by mass |
| Methyl ethyl ketone | 10.0 parts by mass |

Here, DPHA and IRGACURE 184 are as follows.

### DPHA:

A mixture of dipentaerythritol pentaacrylate and dipentaerythritol hexaacrylate (produced by Nippon Kayaku Co., Ltd.)

### IRGACURE 184:

A photopolymerization initiator, produced by Ciba Specialty Chemicals Corp. Formulation of Coating Solution (H-3) for Hardcoat Layer:

| | | |
|---|---|---|
| DPHA | 30.3 | parts by mass |
| Z7404 | 30.6 | parts by mass |
| IRGACURE 907 | 0.9 | parts by mass |
| Methyl isobutyl ketone | 29.3 | parts by mass |
| Methyl ethyl ketone | 8.8 | parts by mass |

Here, Z7404 and IRGACURE 907 are as follows.

### Z7404:

Zirconia-containing UV-curable hardcoat solution (produced by JSR Corp., solid content concentration: about 61.2%, ZrO₂ content: about 69.6% based on solid content, polymerizable monomer, containing polymerization initiator)

### IRGACURE 907:

A photopolymerization initiator, produced by Ciba Specialty Chemicals Corp.

### [Preparation of Coating Solution for Intermediate Layer]

The components shown below were charged into a mixing tank and after stirring, the resulting solution was filtered through a polypropylene-made filter having a pore size of 3 μm to prepare the coating solution.

### Formulation of Coating Solution (M-1) for Intermediate Layer:

| | |
|---|---|
| DPCA-120 | 4.75 parts by mass |
| IRGACURE 907 | 0.25 parts by mass |
| Methyl isobutyl ketone | 76.0 parts by mass |
| Methyl ethyl ketone | 19.0 parts by mass |

Here, DPCA-120 is as follows:

### DPCA-120:

A mixture of ethylene oxide-modified pentaerythritol triacrylate and pentaerythritol tetraacrylate [produced by Nippon Kayaku Co., Ltd.].

### [Preparation of Coating Solution for Low Refractive Index Layer]

### (Preparation of Sol Solution a)

In a reaction vessel equipped with a stirrer and a reflux condenser, 120 parts by mass of methyl ethyl ketone, 100 parts by mass of acryloxypropyltrimethoxysilane “KBM-5103” {produced by Shin-Etsu Chemical Co., Ltd.} and 3 parts by mass of diisopropoxyaluminum ethyl acetate were added and mixed and after adding 30 parts by mass of ion-exchanged water, the reaction was allowed to proceed at 60° C. for 4 hours. The reaction solution was then cooled to room temperature to obtain Sol Solution a. The mass average molecular weight measured by the GPC method was 1,800 and out of the oligomer or higher components, the proportion of the components having a molecular weight of 1,000 to 20,000 was 100 mass %. Also, the gas chromatography analysis revealed that the raw material acryloxypropyltrimethoxysilane did not remain at all.

### (Preparation of Hollow Silica Fine Particle Liquid Dispersion (A-1))

30 Parts by mass of acryloyloxypropyltrimethoxysilane “KBM-5103” {produced by Shin-Etsu Chemical Co., Ltd.} and 1.5 parts by mass of diisopropoxyaluminum ethyl acetate “Kerope EP-12” {produced by Hope Chemical Co., Ltd.} were added to 500 parts by mass of a hollow silica fine particle sol (particle size: approximately from 40 to 50 nm, thickness of shell: from 6 to 8 nm, refractive index: 1.31, solid content concentration: 20 mass %, main solvent: isopropyl alcohol, prepared according to Preparation Example 4 of JP-A-2002-79616 by changing the particle size) and mixed, and 9 parts by mass of ion-exchanged water was added thereto. After allowing the reaction to proceed at 60° C. for 8 hours, the reaction solution was cooled to room temperature, and 1.8 parts by mass of acetyl acetone was added to obtain Hollow Silica Liquid Dispersion (A-1). In the obtained hollow silica liquid dispersion, the solid content concentration was 18 mass % and the refractive index after drying the solvent was 1.31.

### (Preparation of Coating Solution (L-1) for Low Refractive Index Layer)

44.0 Parts by mass of a fluorine-containing copolymer (P-3, weight average molecular weight: about 50,000) described in JP-A-2004-45462), 6.0 parts by mass of a mixture of dipentaerythritol pentaacrylate and dipentaerythritol hexaacrylate “DPHA” {produced by Nippon Kayaku Co., Ltd.}, 3.0 parts by mass of terminal methacrylate group-containing silicone “RMS-033” (produced by Gelest), and 3.0 parts by mass of “IRGACURE 907” {produced by Ciba Specialty Chemicals Corp.} were added to 100 parts by mass of methyl ethyl ketone and dissolved. Thereafter, 195 parts by mass of Hollow Silica Fine Particle Liquid Dispersion (A-1) (35.1 parts by mass as the solid content of silica+surface treating agent) and 17.2 parts by mass (5.0 parts by mass as the solid content) of Sol Solution a were added. The resulting solution was diluted with cyclohexane and methyl ethyl ketone such that the solid content concentration in the entire coating solution became 6 mass % and the ratio between cyclohexane and methyl ethyl ketone became 10:90, whereby Coating Solution (L-1) for Low Refractive Index Layer was prepared.

### [Coating of Intermediate Layer]

Using the slot die coater shown in FIG. 1 of JP-A-2003-211052, Transparent Support 11 was unrolled and Coating Solution (M-1) for Intermediate Layer was wet-coated thereon to give an intermediate layer having a dry thickness of 91 nm and dried at 60° C. for 50 seconds, and an ultraviolet ray was then irradiated thereon at an irradiation dose of 200 mJ/cm² by using “Air-Cooled Metal Halide Lamp” {manufactured by Eye Graphics Co., Ltd.} of 240 W/cm in an atmosphere having an oxygen concentration of 100 ppm under nitrogen purging to form an intermediate layer. The resulting film was taken up. In this way, a transparent support with an intermediate layer (Transparent Support 11′) was produced.

### [Coating of Hardcoat Layer]

Using the slot die coater shown in FIG. 1 of JP-A-2003-211052, Transparent Supports 1 to 10 and Transparent Support 11′ prepared above each was unrolled, and Coating Solutions 1 to 3 (H-1 to H-3) for Hardcoat Layer each was coated thereon to give a dry thickness shown in Table 3 and dried at 30° C. for 15 seconds and further at 90° C. for 20 seconds. Thereafter, the coating layer was cured by irradiating an ultraviolet ray at an irradiation dose of 130 mJ/cm² with use of “Air-Cooled Metal Halide Lamp” {manufactured by Eye Graphics Co., Ltd.} of 160 W/cm under nitrogen purging to produce Hardcoat Films (HC-1) to (HC-11), and the resulting film was taken up. The hardcoat layer was coated on the side where the surface layer was provided.

### [Coating of Low Refractive Index Layer]

Coating Solution (L-1) for Low Refractive Index Layer was wet-coated on each of Hardcoat Films (HC-2 and HC-7) by using the slot die coater shown in FIG. 1 of JP-A-2003-211052 to give a low refractive index layer having a dry thickness of 90 nm, dried at 60° C. for 50 seconds and then irradiated with an ultraviolet ray at an irradiation dose of 600 mJ/cm² by using “Air-Cooled Metal Halide Lamp” {manufactured by Eye Graphics Co., Ltd.} of 240 W/cm in an atmosphere having an oxygen concentration of 100 ppm under nitrogen purging to form a low refractive index layer. The refractive index of the low refractive index layer after curing was 1.38.

TABLE 3

| | | | Intermediate Layer | | | Hardcoat Layer | | |
|---|---|---|---|---|---|---|---|---|
| | Hardcoat | | Coating | Refractive | Film | Coating | Film | Refractive |
| | Film | Transparent Support | Solution | Index | Thickness | Solution | Thickness | Index |
| Example 1 | HC-1 | Transparent Support 1 | — | — | — | H-1 | 8 μm | 1.51 |
| Example 2 | HC-2 | Transparent Support 2 | — | — | — | H-2 | 11 μm | 1.53 |
| Example 3 | HC-3 | Transparent Support 3 | — | — | — | H-2 | 11 μm | 1.53 |
| Comparative | HC-4 | Transparent Support 4 | — | — | — | H-2 | 11 μm | 1.53 |
| Example 1 | | | | | | | | |
| Example 4 | HC-5 | Transparent Support 5 | — | — | — | H-2 | 11 μm | 1.53 |
| Comparative | HC-6 | Transparent Support 6 | — | — | — | H-2 | 11 μm | 1.53 |
| Example 2 | | | | | | | | |
| Example 5 | HC-7 | Transparent Support 7 | — | — | — | H-3 | 6 μm | 1.6 |
| Example 6 | HC-8 | Transparent Support 8 | — | — | — | H-3 | 6 μm | 1.6 |
| Comparative | HC-9 | Transparent Support 9 | — | — | — | H-3 | 6 μm | 1.6 |
| Example 3 | | | | | | | | |
| Comparative | HC-10 | Transparent Support 10 | — | — | — | H-1 | 8 μm | 1.51 |
| Example 4 | | | | | | | | |
| Comparative | HC-11 | Transparent Support 11 | M-1 | 1.507 | 91 nm | H-2 | 11 μm | 1.53 |
| Example 5 | | | | | | | | |

| | Low Refractive Index Layer | Interference | | | | Value of |
|---|---|---|---|---|---|---|
| | Coating Solution | Unevenness | Adherence | Reflectance | Display Quality | Formula (I) |
| Example 1 | — | A | A | 4.5% | B | 1 |
| Example 2 | L-1 | A | A | 1.5% | A | 1 |
| Example 3 | — | B | A | 4.5% | B | 1 |
| Comparative | — | C | A | 4.5% | C | 1 |
| Example 1 | | | | | | |
| Example 4 | — | B | A | 4.5% | B | 1 |
| Comparative | — | C | A | 4.5% | C | 1 |
| Example 2 | | | | | | |
| Example 5 | L-1 | A | A | 0.9% | A | 1 |
| Example 6 | — | B | A | 4.5% | B | 0.986 |
| Comparative | — | C | A | 4.5% | C | 0.976 |
| Example 3 | | | | | | |
| Comparative | — | C | A | 4.5% | C | — |
| Example 4 | | | | | | |
| Comparative | — | A | B | 4.5% | B | 1 |
| Example 5 | | | | | | |

### [Evaluation of Hardcoat Film]

Hardcoat Films HC-1 to HC-11 (here, RC-2 and HC-7 are an embodiment of the antireflection film of the present invention because a low refractive index layer is provided on a hard coat layer, but for the sake of convenience, these films are referred to as a hardcoat film) were evaluated as follows. The evaluation results are shown in Table 3.

### (Interference Unevenness)

After blacking out the back surface of the hardcoat film by a black marker, the surface of the hardcoat film was observed under a three band fluorescent lamp with a diffuser panel on front. In the criteria below, the level of B or higher was judged as “passed”.

A: Interference unevenness was invisible.

B: Interference unevenness was slightly visible but not annoying.

C: Interference unevenness was visible and annoying.

### (Adherence)

The surface on the side having the hardcoat layer was incised with a cutter knife to form 11 longitudinal lines and 11 transverse lines in a grid pattern and thereby define 100 squares in total at intervals of 1 mm, and a test of press-bonding a polyester pressure-sensitive adhesive tape (No. 31B) produced by Nitto Denko Corp. and after standing for 24 hours, peeling off the tape was repeated three times on the same site. The presence or absence of separation was observed with an eye, and when separation was not generated, the sample was rated as passed (A). The sample where separation was generated was rated B. As for RC-2 and HC-7, the evaluation of adherence was performed on the film after a low refractive index layer was stacked.

### (Reflectance)

In the measurement of reflectance, adapter “ARV-474” was loaded in spectrophotometer “V-550” [manufactured by JASCO Corp.], the specular reflectance for the outgoing angle of −5° at an incident angle of 5° in the wavelength region of 380 to 780 nm was measured, and the average reflectance at 450 to 650 nm was calculated.

### [Production of Polarizing Plate]

A polarizing film was produced by adsorbing iodine to a stretched polyvinyl alcohol film. Hardcoat Films (HC-1) to (HC-11) each was saponified and laminated to one side of the polarizing film by using a polyvinyl alcohol-based adhesive, such that the cellulose triacetate side of each hardcoat film came to the polarizing film side. Also, a commercially available cellulose triacetate film “FUJITAC TD80UF” {produced by Fujifilm Corp.} was laminated to the polarizing film surface opposite the side where the hardcoat film was laminated, by using a polyvinyl alcohol-based adhesive. In this way, Polarizing Plates (HKH-1) to (HKH-11) with hardcoat film were produced.

### [Evaluation of Polarizing Plate]

The polarizing plate on the viewing side of a 32-type full-spec high vision liquid crystal TV “LC-32GS10” {manufactured by Sharp Corp.} was removed, and Polarizing Plates (HKH-1) to (HKH-11) each was laminated instead to the viewing side through a pressure-sensitive adhesive such that the hardcoat film became the outmost surface.

The screen when the liquid crystal TV was turned off was confirmed in a bright-room environment of 200 cd/m², as a result, only in the portion laminated with HKH-4, an uneven pattern was visually recognized and the display quality was low. In the case of HKH-2 and HKH-7 where a low refractive index layer was provided, disturbing reflection on the screen was suppressed and the display quality was particularly high.

As apparent from the results in Table 3, the hardcoat film of the present invention allows no generation of interference unevenness and at the same time, ensures excellent adherence. Furthermore, the hardcoat film of the present invention can be suitably used for an optical film such as polarizing plate by using a pressure-sensitive adhesive or an adhesive, and an image display device fitted with the optical film can realize high display quality by virtue of no generation of interference unevenness and can be suitably used even as a household television set. In the case of stacking a low refractive index layer on the hardcoat film, disturbing reflection is reduced and higher display quality can be obtained.

According to the present invention, a hardcoat film, an antireflection film, a polarizing plate and a display device, in which interference unevenness can be suppressed without reducing the adherence, can be provided. Also, a production method capable of producing a hardcoat film without increasing the number of coatings can be provided.

The entire disclosure of each and every foreign patent application from which the benefit of foreign priority has been claimed in the present application is incorporated herein by reference, as if fully set forth.

1. A hardcoat film, comprising:
a cellulose acylate film containing at least a base layer and a surface layer; and
a hardcoat layer disposed at a surface layer side of the cellulose acylate film,
wherein the surface layer contains inorganic oxide fine particles and a cellulose acylate,
the surface layer has a refractive index of from 1.49 to 1.57 and an average film thickness of from 50 to 130 nm, and
the hardcoat film satisfies formula (I):
0.98<(nH×nC)^{1/2}/nS<1.02 Formula (I)
where nH represents a refractive index of the hardcoat layer; nS represents a refractive index of the surface layer; and nC represents a refractive index of the cellulose acylate film other than the surface layer.

2. The hardcoat film according to claim 1,
wherein the inorganic oxide fine particles contained in the surface layer include inorganic oxide fine particles of a metal selected from Al, Ti, Zr, Sb, Zn, Sn and In, and
an average particle diameter of the inorganic oxide fine particles is from 1 to 100 nm.

3. A method for producing a hardcoat film, the hardcoat film including:
a cellulose acylate film containing at least a base layer and a surface layer; and
a hardcoat layer disposed at a surface layer side of the cellulose acylate film,
wherein the surface layer contains inorganic oxide fine particles and a cellulose acylate,
the surface layer has a refractive index of from 1.49 to 1.56 and an average film thickness of from 50 to 130 nm, and
the hardcoat film satisfies formula (I):
0.98<(nH×nC)^{1/2}/nS<1.02 Formula (I)
where nH represents a refractive index of the hardcoat layer; nS represents a refractive index of the surface layer; and nC represents a refractive index of the cellulose acylate film other than the surface layer, and
the cellulose acylate film is produced by a co-casting method.

4. The method for producing the hardcoat film according to claim 3,
wherein the inorganic oxide fine particles contained in the surface layer include inorganic oxide fine particles of a metal selected from Al, Ti, Zr, Sb, Zn, Sn and In, and
an average particle diameter of the inorganic oxide fine particles is from 1 to 100 nm.

5. An antireflection film, comprising:
a hardcoat film, comprising:
a cellulose acylate film containing at least a base layer and a surface layer; and
a hardcoat layer disposed at a surface layer side of the cellulose acylate film,
wherein the surface layer contains inorganic oxide fine particles and a cellulose acylate,
the surface layer has a refractive index of from 1.49 to 1.57 and an average film thickness of from 50 to 130 nm, and
the hardcoat film satisfies formula (I)
0.98<(nH×nC)^{1/2}/nS<1.02 Formula (I)
where nH represent a refractive index of the hardcoat layer; nS represents a refractive index of the surface layer; and nC represents a refractive index of the cellulose acylate film other than the surface layer; and
a layer disposed at an outermost surface of the hardcoat film, the layer having a refractive index lower than that of the hardcoat layer.

6. A polarizing plate, comprising:
a polarizer; and
protective films disposed at both sides of the polarizer,
wherein at least one of the protective films is a hardcoat film, comprising:
a cellulose acylate film containing at least a base layer and a surface layer; and
a hardcoat layer disposed at a surface layer side of the cellulose acylate film,
wherein the surface layer contains inorganic oxide fine particles and a cellulose acylate,
the surface layer has a refractive index of from 1.49 to 1.57 and an average film thickness of from 50 to 130 nm, and
the hardcoat film satisfies formula (I):
0.98<(nH×nC)^{1/2}/nS<1.02 Formula (I)
where nH represents a refractive index of the hardcoat layer; nS represents a refractive index of the surface layer; and nC represents a refractive index of the cellulose acylate film other than the surface layer.

7. A display device, comprising:
a hardcoat film, comprising:
a cellulose acylate film containing at least a base layer and a surface layer; and
a hardcoat layer disposed at a surface layer side of the cellulose acylate film,
wherein the surface layer contains inorganic oxide fine particles and a cellulose acylate,
the surface layer has a refractive index of from 1.49 to 1.57 and an average film thickness of from 50 to 130 nm, and
the hardcoat film satisfies formula (I):
0.98<(nH×nC)^{1/2}/nS<1.02 Formula (I)
where nH represents a refractive index of the hardcoat layer; nS represents a refractive index of the surface layer; and nC represents a refractive index of the cellulose acylate film other than the surface layer, the hardcoat film disposed at a surface of the display device.
